(19) United States
(12) Patent Application Publication
(10) Pub. No.: US 2026/0267258 A1
(43) Pub. Date: Sep. 10, 2026

(54) ELECTROPHOTOGRAPHIC MEMBER, DEVELOPING APPARATUS, ELECTROPHOTOGRAPHIC PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: TAKASHI KOYANAGI, Shizuoka (JP); SOUYA YAMANE, Shizuoka (JP)

(21) Appl. No.: 19/555,573

(22) Filed: Mar. 3, 2026

(30) Foreign Application Priority Data
Mar. 5, 2025 (JP) 2025-034956

(51) Int. Cl. G03G 15/08; G03G 5/05; G03G 21/18

(52) U.S. Cl. CPC G03G 15/0818; G03G 5/0546; G03G 5/0575; G03G 5/0596; G03G 21/1814; G03G 2215/0861

(57) ABSTRACT

The present disclosure is directed to providing an electrophotographic member capable of stably forming a high-quality electrophotographic image even when used to form a large number of electrophotographic images for a long time in a low-temperature environment. In order solve the problems, the present disclosure provides an electrophotographic member, wherein a first resin is a crosslinked urethane resin containing, a second resin is a crosslinked acrylic resin, and when a region extending from an outer surface of a conductive layer to a depth of 0.1 μm is defined as a first region, the first resin and the second resin form an interpenetrating polymer network structure in the first region.

### BACKGROUND

### Field of the Technology

The present disclosure relates to an electrophotographic member, and a developing apparatus incorporated into an apparatus employing an electrophotographic system. The present disclosure also relates to an electrophotographic process cartridge including the developing apparatus, and an electrophotographic image forming apparatus.

### Description of the Related Art

In an electrophotographic image forming apparatus (also referred to as an “electrophotographic apparatus”), electrophotographic members equipped with a conductive layer are used as, for example, a developing member, a charging member, a toner supply member and a cleaning member. The conductive layer of the electrophotographic member is controlled, for example, to have an electric resistance value in the range from 1.0×10⁵Ω to 1.0×10⁹Ω.

Furthermore, the conductivity needs to be uniform throughout the entire member and remain stable over time. As a conductive agent used for imparting prescribed conductivity to the conductive layer, a conductive particle such as carbon black, and an ionic conductive agent such as a salt compound of a sulfonylimide anion and a metal cation are used.

An electronically conductive roller formed by adding a conductive particle such as carbon black has an advantage that changes such as an increase in resistance due to uneven distribution of the conductive component are unlikely to occur even in long-term energization. On the other hand, however, a conductive particle such as carbon black is difficult to disperse uniformly, and hence locally high-resistance or low-resistance areas may be formed in some cases.

An ionically conductive roller formed by adding an ionic conductive agent can reduce variations in electrical resistance value caused by uneven dispersion of the conductive agent compared to an electronically conductive roller, and hence locally high-resistance or low-resistance areas are less likely to be formed. Therefore, in a developing roller, a developer can be uniformly developed on a photosensitive member, and in a charging roller, the surface of the photosensitive member can be uniformly charged.

Furthermore, in order to exhibit high conductivity throughout the service life, it is necessary to reduce the transfer of substances from contact members to the surface of the electrophotographic member. The transferred substances can increase the resistance of the surface of the electrophotographic member and degrade image quality in some cases, which is particularly pronounced in high-temperature and high-humidity environments. For preventing such member contamination, countermeasures that increase the hardness of the outermost surface and reduce the tackiness of a polymer resin have been disclosed.

Japanese Patent Laid-Open No. 2021-176003 discloses a technology regarding an electrophotographic member capable of achieving uniform conductivity thereof and excellent charging performance of a developer, while suppressing the transfer of substances from other members. In this electrophotographic member, at least one of a crosslinked acrylic resin having an ether bond and a crosslinked epoxy resin having an ether bond forms an interpenetrating polymer network structure within a first region extending from the outer surface to a depth of 0.1 μm in a crosslinked urethane resin that contains an anion and has a specific cationic structure within the molecule thereof.

In recent years, electrophotographic apparatuses are required to maintain high image quality and high durability even in harsher environments and during higher-speed electrophotographic processes. The present inventors installed the conductive roller described in Japanese Patent Laid-Open No. 2021-176003 as a developing roller in an electrophotographic process cartridge, and used this process cartridge to output a large number of electrophotographic images in a 0° C. environment. As a result, as the number of output sheets increased, the occurrence of ghosting in the electrophotographic images was observed in some cases.

At least one aspect of the present disclosure is directed to providing an electrophotographic member that contributes to stable formation of high-quality electrophotographic images in a low-temperature environment.

At least one aspect of the present disclosure is directed to providing an electrophotographic process cartridge that contributes to stable formation of high-quality electrophotographic images.

### SUMMARY

To solve the above-described problems, the present disclosure provides an electrophotographic member including a substrate, and a conductive layer on the substrate, wherein the conductive layer has a thickness of 0.1 μm or more, the conductive layer contains a first resin, a second resin and a bis(fluorosulfonyl)imide anion, the first resin is a crosslinked urethane resin containing, in a molecule, at least one selected from the group consisting of a cationic structure represented by the following formula (C-1) and a cationic structure represented by the following formula (C-2) as well as a polymer chain, the second resin is a crosslinked acrylic resin containing, in a molecule, at least one selected from the group consisting of a partial structure represented by the following formula (C-3), a partial structure represented by the following formula (C-4) and a partial structure represented by the following formula (C-5) as well as a polymer chain, and when a region extending from an outer surface of the conductive layer to a depth of 0.1 μm is defined as a first region, the first resin and the second resin form an interpenetrating polymer network structure in the first region:

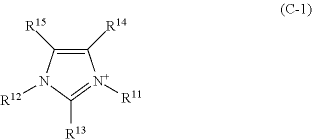

wherein R¹¹ to R¹⁵ are each independently any one selected from the group consisting of the following (a) to (c), and any two of R¹¹ to R¹⁵ are (c):
(a) a hydrogen atom;
(b) a saturated hydrocarbon group having 1 to 6 carbon atoms; and
(c) a structure including a moiety bonded to the polymer chain of the crosslinked urethane resin,

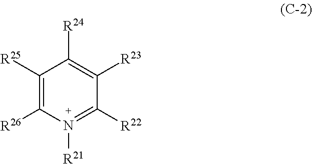

wherein R²¹ to R²⁶ are each independently any one selected from the group consisting of the (a) to (c), and any two of R²¹ to R²⁶ are (c),

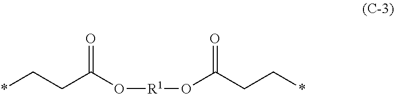

wherein R¹ represents a structure containing carbon, hydrogen and oxygen, having 2 to 8 carbon atoms, and * represents a structure including a moiety bonded to the polymer chain of the crosslinked acrylic resin,

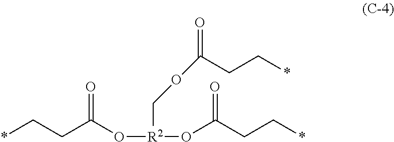

wherein R² represents a structure containing carbon, hydrogen and oxygen, having 3 to 8 carbon atoms, and * represents a structure including a moiety bonded to the polymer chain of the crosslinked acrylic resin, and

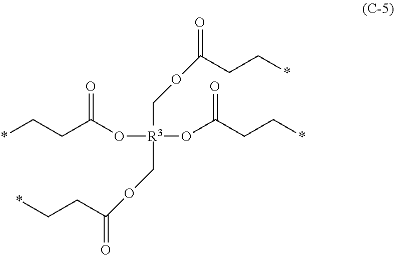

wherein R³ represents a structure containing carbon, hydrogen and oxygen, having 3 to 8 carbon atoms, and * represents a structure including a moiety bonded to the polymer chain of the crosslinked acrylic resin.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic cross-sectional view of an example of an electrophotographic roller according to one aspect of the present disclosure.

FIG. 1B is a schematic cross-sectional view of another example of the electrophotographic roller according to one aspect of the present disclosure.

FIG. 1C is a schematic cross-sectional view of still another example of the electrophotographic roller according to one aspect of the present disclosure.

FIG. 2 is a schematic diagram illustrating the structure of an example of a process cartridge according to one aspect of the present disclosure.

FIG. 3 is a schematic cross-sectional view of an example of an electrophotographic apparatus according to one aspect of the present disclosure.

FIG. 4A is an exemplified schematic diagram of the structure of a jig for evaluating a resistance value of a developing roller.

FIG. 4B is another exemplified schematic diagram of the structure of the jig for evaluating a resistance value of a developing roller.

FIG. 5 is a schematic cross-sectional view of an example of a blade member according to one aspect of the present disclosure.

FIG. 6 is an exemplary diagram of microsampling mass spectrometry.

### DESCRIPTION OF THE EMBODIMENTS

In the present disclosure, a numerical range expressed as “XX or more and YY or less” or “XX to YY” includes the lower and upper limits that are the end points unless otherwise specified. When numerical ranges are described in a stepwise manner, the upper and lower limits of the respective ranges can be combined arbitrarily.

In the present disclosure, the expression “at least one selected from the group consisting of XX, YY, and ZZ” means any of XX, YY, ZZ, a combination of XX and YY, a combination of XX and ZZ, a combination of YY and ZZ, and a combination of XX, YY, and ZZ.

### One Embodiment

One embodiment relates to an electrophotographic member.

The electrophotographic member of the present disclosure includes a substrate, and a conductive layer on the substrate, wherein the conductive layer has a thickness of 0.1 μm or more, the conductive layer contains a first resin, a second resin and a bis(fluorosulfonyl)imide anion, the first resin is a crosslinked urethane resin containing, in a molecule, at least one selected from the group consisting of a cationic structure represented by the following formula (C-1) and a cationic structure represented by the following formula (C-2) as well as a polymer chain, the second resin is a crosslinked acrylic resin containing, in a molecule, at least one selected from the group consisting of a partial structure represented by the following formula (C-3), a partial structure represented by the following formula (C-4) and a partial structure represented by the following formula (C-5) as well as a polymer chain, and when a region extending from an outer surface of the conductive layer to a depth of 0.1 μm is defined as a first region, the first resin and the second resin form an interpenetrating polymer network structure in the first region:

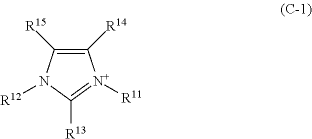

wherein R¹¹ to R¹⁵ are each independently any one selected from the group consisting of the following (a) to (c), and any two of R¹¹ to R¹⁵ are (c):
(a) a hydrogen atom;
(b) a saturated hydrocarbon group having 1 to 6 carbon atoms; and
(c) a structure including a moiety bonded to the polymer chain of the crosslinked urethane resin,

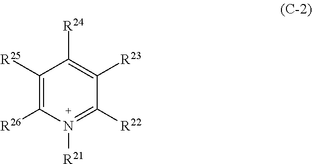

wherein R²¹ to R²⁶ are each independently any one selected from the group consisting of the (a) to (c), and any two of R²¹ to R²⁶ are (c),

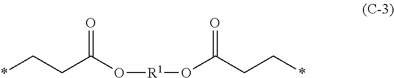

wherein R¹ represents a structure containing carbon, hydrogen and oxygen, having 2 to 8 carbon atoms, and * represents a structure including a moiety bonded to the polymer chain of the crosslinked acrylic resin,

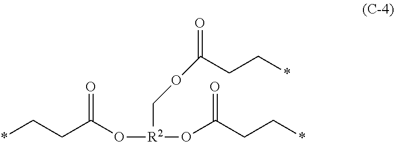

wherein R² represents a structure containing carbon, hydrogen and oxygen, having 3 to 8 carbon atoms, and * represents a structure including a moiety bonded to the polymer chain of the crosslinked acrylic resin, and

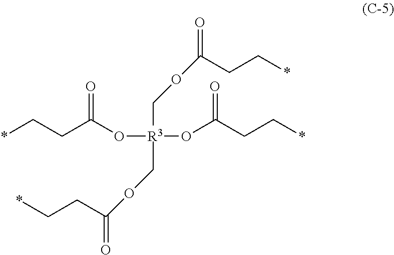

wherein R³ represents a structure containing carbon, hydrogen and oxygen, having 3 to 8 carbon atoms, and * represents a structure including a moiety bonded to the polymer chain of the crosslinked acrylic resin.

The present inventors have confirmed that, by an electrophotographic image output test using the conductive roller according to Japanese Patent Laid-Open No. 2021-176003 under a low-temperature environment, the electrical resistance of the surface of the conductive roller increased immediately after the occurrence of ghosting. From this, it was inferred that the occurrence of ghosting, particularly in a harsh low-temperature environment, is caused by accumulation of electrical charge on the conductive roller as the number of output electrophotographic images increases.

### <<Improvement Mechanism>>

The present inventors presume that the reason why the electrophotographic member having the structure of the present disclosure is unlikely to cause ghosting, even when used to form a large number of electrophotographic images in a low-temperature environment, is as follows.

In an environment at room temperature or higher, a molecule can undergo thermal motion without particular restriction, but in a low-temperature environment, thermal mobility is restricted, which decreases molecular mobility. In such a case, ionic species with a large ionic radius is further hindered by its own spatial bulkiness, and hence the decrease in the molecular mobility is accelerated.

In Japanese Patent Laid-Open No. 2021-176003, in the crosslinked urethane resin having the specific structure in the molecule, at least one of the crosslinked acrylic resin having an ether bond and the crosslinked epoxy resin having an ether bond constitutes an interpenetrating polymer network structure in the first region extending from the outer surface to a depth of 0.1 μm.

In an environment at room temperature or higher, this interpenetrating polymer network structure favorably suppresses the mobility of the crosslinked urethane resin and inhibits the migration of a free cation to the outermost surface, and decrease in triboelectric charge of a developer is thus suppressed. On the other hand, in a low-temperature environment, such an interpenetrating polymer network structure can act in a direction that hinders the molecular mobility of an anion.

Furthermore, the crosslinked acrylic resin or crosslinked epoxy resin of Japanese Patent Laid-Open No. 2021-176003 has an ether bond within its molecule. The ether bond can cause electrostatic repulsion with an anion due to the high electron density thereof. Since this interpenetrating structure is formed on the outermost surface, an anion is difficult to migrate to the outermost surface both spatially and electrically, and charge accumulation on the conductive roller is caused, which is considered to be the factor causing the ghosting.

In order to overcome these problems, the present inventors have considered that a structure satisfying the following conditions would be effective:
(i) selecting an anion with a sufficiently small ionic radius; and
(ii) sufficiently decreasing the content of electron-rich oxygen-containing functional groups.

The present inventors have examined a structure of an electrophotographic member satisfying the conditions (i) and (ii). As a result, the structure of the present disclosure has been achieved.

The fluorosulfonylimide contained in the structure of the present disclosure has a smaller ionic radius than the trifluorosulfonylimide described in Japanese Patent Laid-Open No. 2021-176003, and therefore, is less susceptible to the thermal mobility restriction imposed by an IPN structure. Furthermore, since impregnating agents having the structures represented by the formulae (C-3) to (C-5) are used, electrostatic repulsion is effectively limited. It is considered that for these reasons, the electrophotographic member of the present disclosure is favorably increased in conductivity on the outermost surface with substances transferred from other members suppressed, and thus can obtain an output image with uniform density and free from ghosting.

### <<Conductive Layer>>

In the electrophotographic member of the present disclosure, the conductive layer has a thickness of 0.1 μm or more, and the conductive layer contains the first resin, the second resin and a bis(fluorosulfonyl)imide anion. In the present disclosure, the thickness of the conductive layer can be confirmed by observation of the cross-section with a scanning electron microscope (SEM).

### <Anion>

An anionic component of the present disclosure preferably contains, as the anion, a bis(fluorosulfonyl)imide anion (also referred to as an FSI anion) because such a component has high ion mobility in the first and second resins, and tends to migrate easily using the concentration gradient as a driving force when anions are localized by energization. In the present disclosure, it is preferable that the bis(fluorosulfonyl)imide anion occupies 80% by mass or more of anionic components contained in the conductive layer.

In the present disclosure, it is preferable that the content of the anionic component in the conductive layer is 0.01 parts by mass or more and 0.2 parts by mass or less based on 100 parts by mass of the total content of the first resin and the second resin in the conductive layer. In this manner, an electrophotographic member that contributes to more stable formation of a higher quality electrophotographic image in a low-temperature environment can be provided.

### <First Resin>

In the electrophotographic member of the present disclosure, the first resin is a crosslinked urethane resin containing, in a molecule, at least one selected from the group consisting of a cationic structure represented by the following formula (C-1) and a cationic structure represented by the following formula (C-2) as well as a polymer chain:

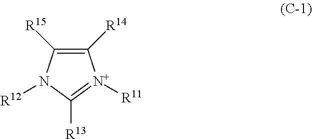

wherein R¹¹ to R¹⁵ are each independently any one selected from the group consisting of the following (a) to (c), and any two of R¹¹ to R¹⁵ are (c):
(a) a hydrogen atom;
(b) a saturated hydrocarbon group having 1 to 6 carbon atoms; and
(c) a structure including a moiety bonded to the polymer chain of the crosslinked urethane resin, and

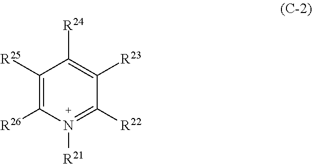

wherein R²¹ to R²⁶ are each independently any one selected from the group consisting of the (a) to (c), and any two of R²¹ to R²⁶ are (c).

In the present disclosure, the structure and amount of each resin can be confirmed by, for example, nuclear magnetic resonance (NMR) spectroscopy and matrix-assisted laser desorption/ionization mass spectrometry (MALDI-MS).

Examples of (b) the saturated hydrocarbon group having 1 to 6 carbon atoms include straight-chain alkyl groups such as a methyl group, an ethyl group, a n-propyl group, a n-butyl group, a n-pentyl group, and a n-hexyl group, branched-chain alkyl groups such as an isopropyl group, an isobutyl group, a s-butyl group, a t-butyl group, a 1-methylbutyl group, a 2-methylbutyl group, a 3-methylbutyl group, a 1,1-dimethylpropyl group, a 1,2-dimethylpropyl group, and a 2,2-dimethylpropyl group, and cycloalkyl groups such as a cyclobutyl group, a cyclopentyl group, and a cyclohexyl group.

An example of (c) the structure including a moiety bonded to the polymer chain of the resin via a urethane bond includes a structure after reaction, with an isocyanate group, of a hydroxy group-containing structure, such as a hydroxyethyl group, a hydroxypropyl group, a hydroxybutyl group, a hydroxypentyl group, a hydroxyhexyl group, a hydroxyheptyl group, a hydroxyoctyl group, or a triethylene glycol ether group.

### <Second Resin>

In the electrophotographic member of the present disclosure, the second resin is a crosslinked acrylic resin containing, in a molecule, at least one selected from the group consisting of a partial structure represented by the following formula (C-3), a partial structure represented by the following formula (C-4) and a partial structure represented by the following formula (C-5) as well as a polymer chain:

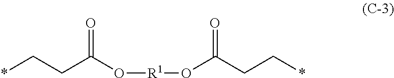

wherein R¹ represents a structure containing carbon, hydrogen and oxygen, having 2 to 8 carbon atoms, and * represents a structure including a moiety bonded to the polymer chain of the crosslinked acrylic resin,

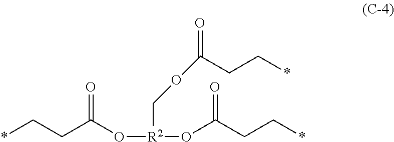

wherein R² represents a structure containing carbon, hydrogen and oxygen, having 3 to 8 carbon atoms, and * represents a structure including a moiety bonded to the polymer chain of the crosslinked acrylic resin, and

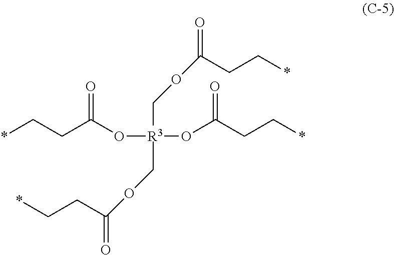

wherein R³ represents a structure containing carbon, hydrogen and oxygen, having 3 to 8 carbon atoms, and * represents a structure including a moiety bonded to the polymer chain of the crosslinked acrylic resin.

In the present disclosure, the monomer forming the second resin is preferably a trifunctional or higher monomer. In this manner, an electrophotographic member that contributes to more stable formation of higher quality electrophotographic images in a low-temperature environment can be provided.

### <<Method for Producing Resin Layer>>

The conductive layer can be formed, for example, by forming, on an elastic layer described below, a coating film of a conductive layer-forming coating material containing raw materials for a resin to be contained in the conductive layer, and then reacting the raw materials for the resin with each other within the coating film.

The coating material contains the following (i) to (iii) as the raw materials for the resin:
(i) An ionic conductive agent for incorporating, into the resin, at least one of cationic partial structures represented by the formula (C-1) and the formula (C-2);
(ii) a polyisocyanate that forms a urethane resin by reacting with the ionic conductive agent; and
(iii) a polyol that forms a urethane resin by reacting with the polyisocyanate (ii).

### <(i) Ionic Conductive Agent>

The ionic conductive agent is a compound having two hydroxyl groups, and possesses a cation and an anion. The structure of the cation corresponds to the compound represented by the formula (C-1) or the formula (C-2).

From the viewpoint of achieving relatively high conductivity in the resulting conductive layer, an imidazolium cation and a pyridinium cation are preferred, and an imidazolium cation is particularly preferred. This is because the positive charge of the imidazolium cation is delocalized over the imidazolium ring, which can relatively suppress the effect of removing the charge of a toner by a cationic organic group.

The anion of the ionic conductive agent is as described above.

The content of the ionic conductive agent is preferably 0.01 parts by mass or more and 20 parts by mass or less relative to the conductive layer. When the content is 0.01 parts by mass or more, a conductive layer with high conductivity can be obtained. When the content is 20 parts by mass or less, a conductive layer with minimal oozing of the ionic conductive agent can be obtained.

The ionic conductive agent of the present disclosure can be obtained by synthesizing a precursor through one or more stages of a known nucleophilic substitution reaction, such as the Menschutkin reaction, followed by a known ion-exchange reaction.

Accordingly, as a nucleophile, a compound having a nucleophilic nitrogen atom, such as an imidazole compound or a pyridine compound, can be used.

As an electrophile, for example, an alkyl halide compound substituted with a hydroxyl group can be used.

Besides, as an alkali metal salt used in the ion-exchange reaction, an alkali metal salt containing the anion according to the present disclosure, such as a lithium fluoroalkyl sulfonate or a potassium fluoroalkyl sulfonyl imide, can be used.

By changing, to a desired combination, the nucleophile and the electrophile used in the nucleophilic substitution reaction and the alkali metal salt used in the ion-exchange reaction, a desired ionic conductive agent can be synthesized through a combination of known methods.

<(ii) Polyisocyanate>

Examples of the isocyanate compound include: aliphatic polyisocyanates such as ethylene diisocyanate and 1,6-hexamethylene diisocyanate (HDI); alicyclic polyisocyanates such as isophorone diisocyanate (IPDI), cyclohexane-1,3-diisocyanate, and cyclohexane-1,4-diisocyanate; and aromatic polyisocyanates such as 2,4-tolylene diisocyanate, 2,6-tolylene diisocyanate (TDI), 4,4′-diphenylmethane diisocyanate (MDI), polymeric diphenylmethane diisocyanate, xylylene diisocyanate, and naphthalene diisocyanate; copolymers of these and isocyanate compounds such as isocyanurate forms, TMP adducts, biuret forms, and blocked forms thereof.

Among these, aromatic polyisocyanates such as tolylene diisocyanate, diphenylmethane diisocyanate, and polymeric diphenylmethane diisocyanate are preferred. These compounds have high reactivity with the hydroxyl group of the cation, and therefore, the proportion of cations that are not bonded to the resin reduces. Consequently, a conductive layer with minimal oozing of the ionic conductive agent can be obtained.

Furthermore, the polyisocyanate is preferably used as an isocyanate-terminated prepolymer obtained by previously reacting a polyether polyol or a polyester polyol, described later, with an isocyanate such as 2,4-tolylene diisocyanate (TDI), 1,4-diphenylmethane diisocyanate (MDI), or isophorone diisocyanate (IPDI).

In this manner, the polyether polyol or polyester polyol, along with the ionic conductive agent or an amino compound, can be dispersed and arranged in the resin. Therefore, a conductive layer with excellent flexibility can be obtained.

The content of the polyisocyanate is preferably such that the proportion of isocyanate groups is in the range of 1.0 to 2.0 relative to the total number, assumed as 1.0, of hydroxyl groups possessed by the ionic conductive agent and hydroxyl groups and/or amino groups possessed by the amino compound. When the proportion is 1.0 or more, a conductive layer with excellent charging properties can be obtained. When the proportion is 2.0 or less, a conductive layer with excellent flexibility can be obtained. Note that when a polyol is used, the aforementioned total number includes the number of hydroxyl groups possessed by the polyol.

<(iii) Polyol>

The conductive layer-forming coating material may further contain a polyol other than the ionic conductive agent and the amino compound (hereinafter also referred to as “another polyol”). The another polyol has a plurality of hydroxyl groups in a molecule, and the hydroxyl groups react with the above-described polyisocyanate. The another polyol is not particularly limited, and examples thereof include a polyether polyol and a polyester polyol.

Examples of the polyether polyol include polyethylene glycol, polypropylene glycol, and polytetramethylene glycol. Examples of the polyester polyol include polyester polyols obtained by a condensation reaction of a diol component such as 1,4-butanediol, 3-methyl-1,4-pentanediol, or neopentyl glycol, or a triol component such as trimethylolpropane with a dicarboxylic acid such as adipic acid, phthalic anhydride, terephthalic acid, or hexahydrophthalic acid.

To the conductive layer, a general resin other than the resin according to the present disclosure, a rubber material, a compounding agent, a conductivity-imparting agent, a non-conductive filler, a cross-linking agent, and a catalyst may be added as necessary, to such an extent that the effects of the present disclosure are not impaired.

Examples of the rubber material include ethylene-propylene-diene copolymer rubber, acrylonitrile-butadiene rubber, chloroprene rubber, natural rubber, isoprene rubber, styrene-butadiene rubber, silicone rubber, epichlorohydrin rubber, and urethane rubber.

Examples of the compounding agent include a filler, a softener, a processing aid, a tackifier, an anti-adhesive agent, and a foaming agent commonly used for resins. As the conductivity-imparting agent, for example, carbon black; a conductive metal such as aluminum or copper; and a fine particle of a conductive metal oxide such as conductive zinc oxide, conductive tin oxide, or conductive titanium oxide can be used.

Examples of the non-conductive filler include silica, quartz powder, titanium oxide, and calcium carbonate. Examples of the cross-linking agent include, but are not limited to, tetraethoxysilane, di-t-butyl peroxide, 2,5-dimethyl-2,5-di(t-butylperoxy) hexane, and dicumyl peroxide.

When surface roughness is required for the conductive layer of the developing member, a fine particle for roughness control may be added to the conductive layer. In particular, when the developing member of the present disclosure is applied to a developing roller, the fine particle for roughness control used in the conductive layer preferably has a volume average particle size of 3 μm to 20 μm, because a developing roller having excellent toner conveying capability can be thus obtained.

The amount of the fine particle added to the conductive layer is preferably 1 part by mass to 50 parts by mass relative to 100 parts by mass of a resin solid content of the conductive layer, because the effects of the present disclosure are thus prevented from being impaired. As the fine particle for roughness control, a fine particle of polyurethane resin, polyester resin, polyether resin, polyamide resin, acrylic resin, or phenol resin can be used.

The method for forming the conductive layer is not particularly limited, and examples include spraying, dipping, and roll coating using the coating material.

The developing member of the present disclosure can be applied to an electrophotographic member such as a developing roller or a developing blade.

When the developing member of the present disclosure is applied to a developing roller in a developing apparatus, the developer may be magnetic or non-magnetic, and may be a one-component or two-component developer. The developing apparatus may be of a non-contact type or a contact type.

### <<Interpenetrating Polymer Network (IPN) Structure>>

In the electrophotographic member of the present disclosure, when a region extending from the outer surface of the conductive layer to a depth of 0.1 μm is defined as a first region, the first resin and the second resin form an interpenetrating polymer network structure in the first region.

When a spatial environment in which the first resin, having a structure expected to exert a cation stabilizing effect, and the second resin capable of acting as the ionic conductive agent, interact with each other is thus achieved, the effects of the present disclosure are further enhanced. In other words, it is preferable that the first resin and the second resin are contained in the first region extending from the outer surface of the conductive layer (the surface on the side opposite to the side facing the substrate) to a depth of 0.1 μm.

When the first resin and the second resin are contained in the first region, the metal cation exhibiting conductivity and the structure stabilizing the cation are spatially close to each other. As a result, the conductivity on the outer surface of the conductive layer can be more favorably enhanced. Besides, in the present disclosure, it is preferable that the first resin and the second resin occupy 80% by mass or more of resins contained in the first region in the conductive layer.

Furthermore, it is particularly effective that the first resin and the second resin form an interpenetrating polymer network structure (IPN structure) in the first region. An IPN structure refers to a structure in which two or more resin network structures interpenetrate and entangle with each other without being bonded by a covalent bond.

When the IPN structure is formed, the aforementioned improvement in conductivity is exhibited on the outer surface of the developing member, and hence resistance unevenness on the surface can be suitably suppressed, and as a result, it is easy to suppress density unevenness in a halftone image and gradation abnormalities caused by charge-up of the surface of the member during image output.

It is considered that the peak top temperature in a thermal chromatogram corresponding to the thermal decomposition temperature of a resin shifts to a higher temperature side when an IPN structure is formed, compared to when the resin exists alone.

Accordingly, by focusing on either the first resin or the second resin in the conductive layer and comparing the peak top temperatures in the thermal chromatogram of one resin before and after the decomposition and removal of the other resin, it can be confirmed that the first resin and the second resin form an IPN structure when the peak top temperature is lower after the decomposition than before the decomposition. Here, the thermal chromatogram is a mass spectrum that can be obtained by microsampling pyrolysis mass spectrometry.

The outline of the microsampling pyrolysis mass spectrometry is as follows.

First, a region to be measured of the electrophotographic member is cut into a thin section with a microtome to prepare a sample. As illustrated in FIG. 6, samples are prepared from three regions referred to as a first region 71, a second region 72, and a third region 73.

The first region is a region from the outer surface of a conductive layer 74 to a depth of 0.1 μm, the second region is a region having a thickness of 0.1 μm from the inner surface of the conductive layer 74 (the surface on the side facing a substrate 75) toward the outer surface, and the third region is a region from 1.0 μm or more to 1.1 μm or less in the depth direction from the outer surface. A sample obtained from the first region is referred to as a first sample, a sample obtained from the second region is referred to as a second sample, and a sample obtained from the third region is referred to as a third sample.

From each of the regions of the conductive layer, a thin section having a size of 100 μm square and a thickness of 0.1 μm is prepared. For the measurement, for example, an ion trap mass spectrometer equipped in a gas chromatography-mass-spectrometer (“Polaris Q” (trade name, manufactured by Thermo Electron Corporation)) is used. The sample is fixed to a filament positioned at the tip of a probe and inserted directly into an ionization chamber.

Thereafter, the sample is rapidly heated from room temperature to a temperature of 1000° C. at a constant heating rate. The sample, having been decomposed and evaporated by heating, is ionized by electron beam irradiation for detection by a mass spectrometer. At this time, under a condition of a constant heating rate, a thermal chromatogram similar to that obtained by a TG-MS (thermogravimetry-mass spectrometry) method, which has a mass spectrum called a total ion chromatogram (TIC), is obtained.

Since a thermal chromatogram for a fragment of a predetermined mass can also be obtained, the peak temperature in the thermal chromatogram corresponding to the decomposition temperature of a desired molecular structure can be obtained. The peak temperature in the thermal chromatogram correlates with the crosslinked structure in a resin structure, and the denser the crosslinking is, the more the peak temperature shifts toward the higher temperature side.

It can be confirmed, as follows, that the first resin and the second resin form an interpenetrating polymer network structure. Specifically, focusing on either the first resin or the second resin, a difference in the peak temperature in the thermal chromatogram of a fragment derived from one resin before and after the decomposition and removal of the other resin may be checked. For example, a difference in the peak temperature in the thermal chromatogram of a fragment derived from the second resin before and after the decomposition and removal of the first resin may be checked.

When the peak top temperature in the thermal chromatogram derived from the second resin measured in the first sample sampled from the first region is defined as A1 (° C.), and the peak top temperature in the thermal chromatogram derived from the second resin measured in the second sample obtained by decomposing the first resin contained in the first sample is defined as A2 (° C.), if the interpenetrating polymer network structure is formed, the A1 and A2 preferably satisfy the relationship represented by the following formula (1):

$$A 1 > A 2 \qquad ( 1 )$$

As a method for decomposing the first resin, the pyridine decomposition method described later can be employed.

In the conductive layer, when the peak top temperature in the thermal chromatogram corresponding to the first resin in the first region is defined as T1 (° C.), and the peak top temperature in the thermal chromatogram corresponding to the first resin contained in the second region having a thickness of 0.1 μm from the inner surface of the conductive layer toward the outer surface is defined as T2 (° C.), the T1 and T2 preferably satisfy the relationship represented by the following formula (3):

$$T 1 > T 2 \qquad ( 3 )$$

It can be confirmed by the above-described microsampling mass spectrometry that the formula (3) is satisfied.

Besides, the T1 and T2 preferably satisfy the following formula (5):

$$( T 1 - T 2 ) > 1. ( ° C . ) \qquad ( 5 )$$

It can be confirmed by the above-described microsampling mass spectrometry that the formula (5) is satisfied.

One of the functions performed by the conductive layer is to mitigate mechanical stress that a developer carrier exerts on a toner. In order to sufficiently exhibit such a function, the conductive layer is preferably flexible.

For that purpose, it is preferable that no IPN structure exists in the second region having a thickness of 0.1 μm from the surface of the conductive layer facing the substrate toward the outer surface. Alternatively, even if an IPN structure exists, for example, it is preferably an IPN structure in which the degree of interpenetration of the second resin is weaker than that in the IPN structure in the first region.

Accordingly, the first region and the second region of the conductive layer preferably satisfy the relationship represented by the formula (3), and particularly preferably satisfy the relationship represented by the formula (5). Here, T1 (C) indicates the peak top temperature in the thermal chromatogram corresponding to the first resin, measured in the sample sampled from the first region. T2 (C) indicates the peak top temperature in the thermal chromatogram corresponding to the first resin, measured from the sample sampled in the second region.

The values of T1 and T2 can be adjusted by the concentration of a treatment liquid, the UV irradiation intensity, and the like.

Besides, when the peak top temperature, in the thermal chromatogram corresponding to the first resin, of the third region from 1.0 μm or more to 1.1 μm or less in the depth direction from the outer surface of the conductive layer is defined as T3 (° C.), it is preferable that the T1, T2 and T3 satisfy the relationship represented by the following formula (6) and the relationship represented by the following formula (7):

$$T 1 > T 3 \qquad ( 6 )$$

$$\vert T 1 - T 3 \vert > \vert T 3 - T 2 \vert \qquad ( 7 )$$

It can be confirmed by the above-described microsampling mass spectrometry that the formula (6) and the formula (7) are satisfied.

In order to better exhibit the functions of the conductive layer, when the region at a depth of 1.0 μm or more an 1.1 μm or less from the outer surface of the conductive layer and having a thickness of 0.1 μm is defined as the third region, it is preferable that no IPN structure exists in the third region adjacent to the first region. Alternatively, even if an IPN structure exists, it is preferably an IPN structure in which the degree of interpenetration of the second resin is weaker than that in the IPN structure in the first region.

Accordingly, when the peak top temperature in the thermal chromatogram corresponding to the first resin, measured in the sample sampled from the third region is defined as T3 (° C.), it is preferable that the T1, T2 and T3 satisfy the relationship represented by the formula (6) and the relationship represented by the formula (7).

The value of T3 can be adjusted by the crosslinking density of the first resin, and the like.

### <Crosslinked Acrylic Resin>

The crosslinked acrylic resin of the present disclosure is a crosslinked acrylic resin containing, in a molecule, at least one selected from the group consisting of the partial structures of the formulae (C-3) to (C-5).

A first region of the elastic layer of the present disclosure extending from the outer surface to a depth of 0.1 μm contains the first resin and the second resin. When the peak area of carbon (1s) atoms having a binding energy peak position in the range of 286.0 eV to 287.0 eV, as measured by electron spectroscopy for chemical analysis (ESCA), of the second sample obtained by decomposing the first resin contained in the first sample is defined as α, and that the peak area of sulfur (2p3/2) atoms having a binding energy peak position in the range of 166.0 eV to 170.0 eV is defined as β, the α and β preferably satisfy the following formula (2):

$$300 > α / β \qquad ( 2 )$$

In ESCA, in the case of a carbon atom to which a single-bonded oxygen is adjacent (—O—C, also referred to as ether carbon), the binding energy of the carbon 1s orbital is in the range of 286.0 eV to 287.0 eV. The α indicates the amount of carbon at a position adjacent to oxygen. In the case of sulfonyl sulfur (O—S—O), the binding energy of the sulfur 2s orbit is in the range of 166.0 eV to 170.0 eV. The β indicates the amount of sulfur corresponding to the sulfonyl group.

The α/β in the formula (2) indicates the amount of ether carbon per amount of sulfonyl sulfur.

When the α/β is smaller than 300, it indicates that the amount of ether carbon per amount of sulfonyl sulfur is relatively small in the first region. In the present disclosure, the amount of electron-rich ether components, which may cause electrostatic repulsion with FSI anion, reduces. Therefore, it can be expected that the opportunity for FSI anion to localize on the outermost surface of the conductive layer increases. As a result, the conductivity on the outermost surface is ensured, and even under a harsh low-temperature environment, charge-up of the electrophotographic member is suppressed, which is expected to lead to suppression of the adverse effects of ghosting.

On the other hand, when the α/β is larger than 300, the amount of electron-rich ether components is larger than that of FSI anion. Therefore, the opportunity for FSI anion to localize on the outermost surface of the conductive layer may be limited. As a result, the conductivity on the outermost surface decreases, and particularly under a harsh low-temperature environment, charge-up of the electrophotographic member is conceived, which is expected to lead to the adverse effects of ghosting in some cases.

Besides, in the present disclosure, when the peak area of carbon (1s) atoms having a binding energy peak position in the range of 288 eV to 290 eV (288.0 eV to 290.0 eV), as measured by electron spectroscopy for chemical analysis (ESCA), of the second sample is defined as γ, it is preferable that the α and γ satisfy the following formula (4):

$$1.5 > α / γ \qquad ( 4 )$$

In ESCA, in the case of carbonyl carbon (O═C), the binding energy of the carbon 1s orbital is 288.0 eV to 290.0 eV.

The γ indicates the amount of carbon corresponding to the carbonyl group. Therefore, the α/γ in the formula (4) indicates the amount of ether carbon (carbon atoms with C—O bonds) per amount of carbonyl carbon. When the α/γ is smaller than 1.5, it indicates that the amount of ether carbon per amount of carbonyl carbon is relatively small in the first region.

In the present disclosure, the amount of electron-rich ether components, which may cause electrostatic repulsion with FSI anions, reduces, while the amount of electron-poor carbonyl components, which can electrostatically attract FSI anions, increases.

At this point, it can be expected that the opportunity for FSI anion to localize on the outermost surface of the conductive layer increases. As a result, the conductivity on the outermost surface is ensured, and even under a harsh low-temperature environment, charge-up of the electrophotographic member is suppressed, which is expected to lead to suppression of the adverse effects of ghosting.

On the other hand, when the α/γ is larger than 1.5, the proportion of electron-rich ether components is increased relative to electron-poor carbonyl components, and hence the opportunity for FSI anion to localize on the outermost surface of the conductive layer may be limited. As a result, the conductivity on the outermost surface decreases, and particularly under a harsh low-temperature environment, charge-up of the electrophotographic member is conceived, which is expected to lead to the adverse effects of ghosting in some cases.

The value of α/γ can be adjusted by changing the structure of the second resin or by changing the content thereof.

### <Other Components>

The conductive layer may contain, in addition to those described above, a conductive substance, a cross-linking agent, a plasticizer, a filler, an extender, a vulcanizing agent, a vulcanization aid, a cross-linking aid, an antioxidant, an anti-aging agent, a processing aid, a leveling agent and the like, as long as the functions of the conductive layer are not impaired.

When surface roughness is required for the conductive layer, the conductive layer may contain a fine particle for imparting roughness to the conductive layer. Specifically, a fine particle of polyurethane resin, polyester resin, polyether resin, polyamide resin, (meth)acrylic resin, polycarbonate resin and the like can be used.

The volume average particle size of the fine particle is preferably 1.0 μm or more and 30 μm or less, and the surface roughness (ten-point average roughness) Rzjis formed by the fine particle is preferably 0.1 μm or more and 20 μm or less. It is noted that Rzjis is a value measured based on JIS B 0601 (1994).

### <<Electrophotographic Member>>

Now, an embodiment for practicing the present disclosure will be described in more detail.

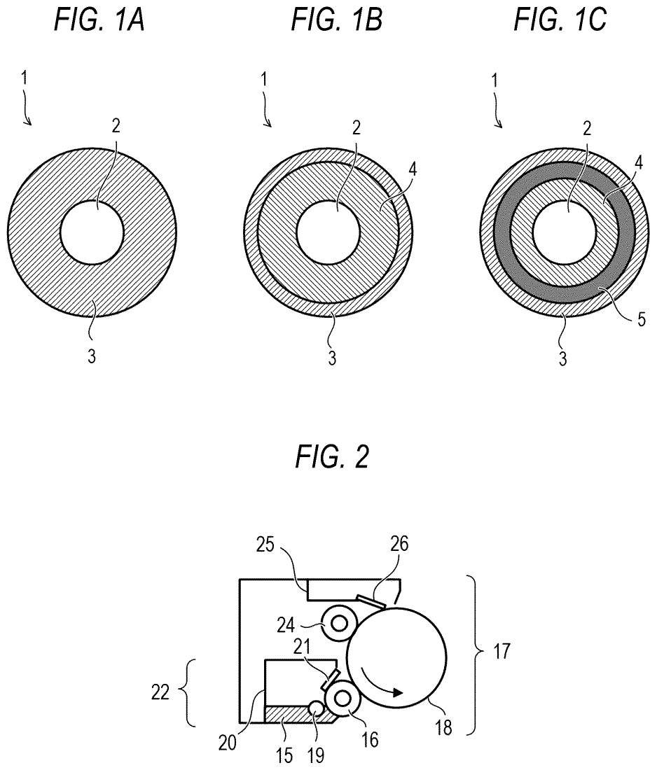

FIGS. 1A to 1C illustrate cross-sectional views, in a direction perpendicular to the axial direction, of a roller-shaped electrophotographic member according to one embodiment of the present disclosure. In a developing roller 1 illustrated in FIG. 1A, a surface layer 3 is formed directly on the outer peripheral surface of a cylindrical or hollow-cylindrical substrate 2.

Alternatively, the developing roller 1 may include, as illustrated in FIG. 1B, one or more elastic layers 4 formed between the substrate 2 and the surface layer 3. Furthermore, the developing roller 1 may have a three-layer structure in which an intermediate layer 5 is disposed between the surface layer 3 and the elastic layer 4 as illustrated in FIG. 1C, or a multilayer structure including a plurality of intermediate layers 5. As the intermediate layer, any of known intermediate layers for a developing roller may be used.

### <Substrate>

The conductive substrate 2 functions as an electrode and a supporting member of the electrophotographic member 1. The substrate is formed of a conductive material, including a metal or alloy such as aluminum, copper alloy, or stainless steel; iron plated with chromium or nickel; or a conductive synthetic resin.

To improve adhesion between the substrate and the elastic layer described later, a primer may be applied to the surface of the substrate. Examples of the primer include a silane coupling agent-based primer, and urethane-based, acrylic-based, polyester-based, polyether-based, or epoxy-based thermosetting or thermoplastic resins.

Examples of commercially available primers include the following:
“DY39-051”, “DY39-012”, and “DY39-115” (all trade names, manufactured by Dow Corning Toray Co., Ltd.);
“X-33-173”, “PRIMER-NO. 4”, “PRIMER-NO. 32”, and “PRIMER-NO. 35” (all trade names, manufactured by Shin-Etsu Chemical Co., Ltd.); and
“XP81-405”, “XP81-A6361”, “XP81-B7015”, “ME21”, “ME151”, “ME153”, and “XC9214” (all trade names, manufactured by Momentive Performance Materials Japan LLC).

A known alkoxysilane, titanate ester or the like may be added to the primer to improve the adhesion thereof. Specific examples of the alkoxysilane and titanate ester include tetramethoxysilane, tetraethoxysilane, tetra-n-butoxysilane, tetraethoxytitanium, tetraisopropoxytitanium, and tetra-n-butoxytitanium. These are preferably added in an amount of 0.1 parts by mass to 20 parts by mass based on 100 parts by mass of the primer.

### <Elastic Layer>

When the electrophotographic member is in a roller shape, namely, is an electrophotographic roller, the elastic layer 4 functions to provide, to the electrophotographic member 1, elasticity necessary to form a nip of a prescribed width at the contact area between the electrophotographic member 1 and a photosensitive member. The elastic layer 4 is preferably a molded body of a rubber material.

As the rubber material, various rubber materials conventionally used for conductive rubber rollers can be used. Specific examples of the rubber used for the rubber material include ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluororubber, silicone rubber, epichlorohydrin rubber, hydrogenated NBR, polysulfide rubber, and urethane rubber. One of these may be singly used, or a mixture of two or more of these may be used. Among these, silicone rubber is preferred from the viewpoint of stability against deformation, such as set properties.

Examples of the silicone rubber include polydimethylsiloxane, polymethyltrifluoropropylsiloxane, polymethylvinylsiloxane, polyphenylvinylsiloxane, and copolymers of these polysiloxanes.

In the elastic layer 4, various additives, such as a conductivity-imparting agent, a non-conductive filler, a cross-linking agent and a catalyst, may be appropriately blended. As the conductivity-imparting agent, carbon black; a fine particle of a conductive metal such as aluminum or copper; or a conductive metal oxide such as zinc oxide, tin oxide or titanium oxide can be used. Among these, carbon black is preferred because good conductivity can be obtained with a relatively small addition amount.

As the carbon black, specifically, conductive carbon black such as Ketjen Black (trade name, manufactured by Lion Corporation) or acetylene black; rubber carbon black such as SAF, ISAF, HAF, FEF, GPF, SRF, FT, or MT; as well as oxidation-treated carbon black for color ink or pyrolytic carbon black can be used.

One of these may be singly used, or two or more of these may be used together. When carbon black is used as the conductivity-imparting agent, it is more preferable that carbon black is blended in an amount of 10 to 80 parts by mass based on 100 parts by mass of rubber contained in the rubber material.

Examples of the non-conductive filler include silica, quartz powder, titanium oxide, zinc oxide, and calcium carbonate. Examples of the cross-linking agent include di-t-butyl peroxide, 2,5-dimethyl-2,5-di(t-butylperoxy) hexane, and dicumyl peroxide. Examples of the catalyst include a platinum-based catalyst, a rhodium-based catalyst, and a palladium-based catalyst, and a platinum-based catalyst is particularly preferred.

The elastic layer 4 may be formed of a plurality of layers. Besides, the intermediate layer 5 may be provided between the substrate 2 and the elastic layer 4, or between the elastic layer 4 and the conductive layer 3. The thickness of the elastic layer 4 is preferably 0.25 mm to 8.00 mm, and more preferably 0.30 mm to 3.00 mm.

### <<Electrophotographic Apparatus>>

The electrophotographic member of the present disclosure can be suitably used as a developer carrier or a developer regulating member in an electrophotographic apparatus. The electrophotographic member can be applied to any of non-contact and contact developing apparatuses using magnetic or non-magnetic one-component toners, and a developing apparatus using two-component toners. In other words, an electrophotographic image forming apparatus of the present disclosure preferably includes the electrophotographic member of the present disclosure as a developing member.

The developing apparatus of the present disclosure includes a toner and a developing roller carrying the toner on the surface thereof, wherein the developing roller includes the electrophotographic member of the present disclosure, the toner includes a toner particle having a toner mother particle containing a binder resin and an organosilicon polymer disposed on a surface of the toner mother particle, and the toner mother particle has, on the surface thereof, a convex portion formed of the organosilicon polymer.

FIG. 2 is a schematic cross-sectional view illustrating an example of an electrophotographic apparatus in which the electrophotographic member of the present disclosure is mounted as a developing roller of a contact-type developing apparatus using a one-component toner. As illustrated in FIG. 2, a developing apparatus 22 is detachably mounted to the electrophotographic apparatus.

The developing apparatus 22 includes a toner container 20 containing a toner 15 as a one-component toner, a developing roller 16, a toner supply roller 19 for supplying the toner to the developing roller 16, and a developing blade 21 for regulating the thickness of the toner layer on the developing roller 16.

The developing roller 16 is positioned at an opening extending in a longitudinal direction within the toner container 20, and is disposed so as to face a photosensitive member 18. Besides, a process cartridge 17, which includes the photosensitive member 18, a cleaning blade 26, a waste toner storage container 25 and a charging roller 24, is detachably mounted to the electrophotographic apparatus. The photosensitive member 18, the cleaning blade 26, the waste toner storage container 25 and the charging roller 24 may be provided in a main body of the electrophotographic apparatus.

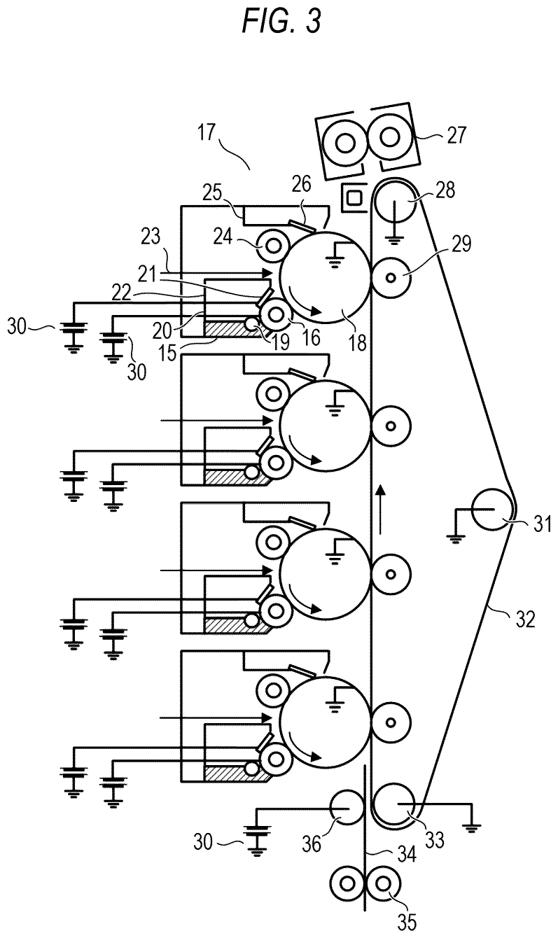

A printing operation of an electrophotographic apparatus will now be described. FIG. 3 is a schematic cross-sectional view of an example of the electrophotographic apparatus according to one aspect of the present disclosure. The photosensitive member 18 rotates in the direction of the arrow and is uniformly charged by the charging roller 24 for charging the photosensitive member 18. Next, an electrostatic latent image is formed on the surface of the photosensitive member 18 by laser light 23, that is, exposure means.

The electrostatic latent image is visualized as a toner image (development) by applying the toner 15 by the developing apparatus 22, which is disposed in contact with the photosensitive member 18. The development is so-called reversal development in which a toner image is formed in an exposed portion.

The toner image formed on the photosensitive member 18 is transferred onto paper 34, that is, a recording medium, by a transfer roller 29 serving as a transfer member. The paper 34 is fed into the apparatus via a paper feed roller 35 and a suction roller 36, and is conveyed between the photosensitive member 18 and the transfer roller 29 by an endless-belt-shaped transfer conveyance belt 32.

The transfer conveyance belt 32 is operated by a driven roller 33, a driving roller 28, and a tension roller 31. A voltage is applied from a bias power source 30 to the transfer roller 29 and the suction roller 36.

The paper 34 onto which the toner image has been transferred is subjected to a fixing process by a fixing unit 27, and is then discharged outside the apparatus, and thus, the printing operation is completed. On the other hand, untransferred toner remaining on the photosensitive member 18 without being transferred is scraped off by the cleaning blade 26, that is, a cleaning member for cleaning the surface of the photosensitive member, and is stored in the waste toner storage container 25. The cleaned photosensitive member 18 repeats this printing operation.

### <<Electrophotographic Process Cartridge>>

The electrophotographic process cartridge of the present disclosure is configured to be detachably mountable to a main body of an electrophotographic image forming apparatus, and includes the developing apparatus of the present disclosure. The electrophotographic image forming apparatus of the present disclosure includes the electrophotographic process cartridge of the present disclosure.

The electrophotographic member of the present disclosure can be suitably used as a developing member, such as a developer carrier, a developer supply/scraping member, and a developer regulating member, in a process cartridge. In other words, the electrophotographic process cartridge of the present disclosure is configured to be detachably mountable to a main body of an electrophotographic apparatus, and may include the electrophotographic member of the present disclosure. Besides, the electrophotographic process cartridge preferably includes the electrophotographic member of the present disclosure as a developing member.

According to at least one aspect of the present disclosure, an electrophotographic member that contributes to stable formation of a high-quality electrophotographic image in a low-temperature environment can be obtained. Besides, according to at least one aspect of the present disclosure, an electrophotographic process cartridge that contributes to stable formation of a high-quality electrophotographic image can be obtained. Furthermore, according to at least one aspect of the present disclosure, an electrophotographic image forming apparatus capable of stably forming a high-quality electrophotographic image can be obtained.

### EXAMPLES

The present disclosure will be described in detail below with reference to specific examples, but the technical scope of the present disclosure is not limited thereto.

### (Production of Elastic Roller K-1)

A primer (trade name: DY35-051; manufactured by Dow Corning Toray Co., Ltd.) was applied to a core metal made of SUS304 and having a diameter of 6 mm and a total length of 278.9 mm, and the resulting core metal was baked for 20 minutes in an oven heated to a temperature of 180° C. to obtain a substrate.

The substrate prepared above was placed in a mold, and an addition-type silicone rubber composition obtained by mixing the following materials was injected into a cavity formed in the mold.

### <Addition-Type Silicone Rubber Composition>

Liquid silicone rubber material (trade name: SE6724A/B; manufactured by Dow Corning Toray Co., Ltd.): 100 parts by mass
Carbon black (trade name: TOKABLACK #4300; manufactured by Tokai Carbon Co., Ltd.): 15 parts by mass
Silica powder serving as heat resistance-imparting agent: 0.2 parts by mass
Platinum catalyst: 0.1 parts by mass

Subsequently, the mold was heated at 150° C. for 15 minutes to vulcanize and cure the silicone rubber. After the substrate having the cured silicone rubber layer formed on its peripheral surface was removed from the mold, the substrate was further heated at 180° C. for 1 hour to complete the curing reaction of the silicone rubber layer. In this manner, an elastic roller K-1 having a silicone rubber elastic layer with a diameter of 12 mm formed on the outer periphery of the substrate was produced.

### (Preparation of Conductive Layer)

A synthesis example for obtaining the conductive layer of the present disclosure will now be described.

### <Synthesis of Ionic Conductive Agent>

### (Synthesis of Ionic Conductive Agent A-1)

A stirring bar and 50 ml of tetrahydrofuran (hereinafter referred to as “THF”; manufactured by Kanto Chemical Co., Inc.) were placed in a recovery flask equipped with a Dimroth condenser, and 12.5 g (0.52 mol) of sodium hydride (manufactured by Kanto Chemical Co., Inc.) was dispersed therein, and the recovery flask was then cooled in an ice bath.

A solution prepared by dissolving 8.8 g (0.13 mol) of G-1 (imidazole; manufactured by Tokyo Chemical Industry Co., Ltd.) as a nucleophile in 50 ml of THF was slowly added dropwise thereto, and the ice bath was removed, followed by stirring at room temperature for 2 hours.

After adding 41.3 g (0.33 mol) of H-1 (2-bromoethanol; manufactured by Tokyo Chemical Industry Co., Ltd.) thereto as an electrophile at room temperature, the resulting mixture was heated under reflux at 70° C. for 7 hours. The reaction solution after the reaction was filtered, the insoluble matter was washed away with THE, and the solvent of the resulting filtrate was distilled off under reduced pressure. The residue was dissolved in dichloromethane again and filtered, and after collecting the filtrate, the solvent was distilled off under reduced pressure to obtain a concentrate.

The thus obtained concentrate was washed with diethyl ether, and dried under reduced pressure to obtain 28 g of an ionic conductive agent precursor. Subsequently, to exchange the anion of the ionic conductive agent to be obtained with a target anion, the whole amount of the obtained ionic conductive agent precursor was dissolved in 100 ml of methanol at room temperature.

With stirring the resultant solution, 27.6 g of ion-exchange salt I-1 (potassium N,N-bis(fluorosulfonyl)imide; manufactured by Mitsubishi Materials Electronic Chemicals Co., Ltd.) dissolved in 50 ml of pure water was added thereto, followed by stirring at room temperature for 24 hours. After the reaction, methanol was distilled off under reduced pressure, the resultant was separated with dichloromethane/water, and the organic layer was collected and further washed twice with water. Then, the solvent was distilled off under reduced pressure, and the resultant was dried to obtain an ionic conductive agent A-1 as a white powder.

### (Synthesis of Ionic Conductive Agents A-4 to A-7 and AH-1)

Ionic conductive agents A-4 to A-7 and AH-1 were obtained in the same manner as in the synthesis of the ionic conductive agent A-1, except that the types and blending amounts of the nucleophile, electrophile, and ion-exchange salt used as raw materials were changed as shown in Table 1. Details of the nucleophile No., electrophile No., and ion-exchange salt No. in Table 1 are shown in Tables 2 to 4.

TABLE 1

| Ionic | Nucleophile | | Electrophile | | Ion-exchange Salt | |
|---|---|---|---|---|---|---|
| Conductive | | Addition | | Addition | | Addition |
| Agent No. | No. | Amount (g) | No. | Amount (g) | No. | Amount (g) |
| A-1 | G-1 | 8.8 | H-1 | 41.3 | I-1 | 27.6 |
| A-4 | G-1 | 8.8 | H-3 | 69.0 | I-1 | 27.6 |
| A-5 | G-2 | 10.7 | H-1 | 41.3 | I-1 | 27.6 |
| A-6 | G-3 | 12.7 | H-1 | 41.3 | I-1 | 27.6 |
| A-7 | G-4 | 13.9 | H-1 | 41.3 | I-1 | 27.6 |
| AH-1 | G-1 | 8.8 | H-1 | 41.3 | I-2 | 57.4 |

TABLE 2

| No. | Nucleophile |
|---|---|
| G-1 | Imidazole (manufactured by Kanto Chemical Co., Inc.) |
| G-2 | 1-Methylimidazole (manufactured by Tokyo Chemical Industry Co., Ltd.) |
| G-3 | 2-(Hydroxymethyl)imidazole (manufactured by Sigma Aldrich) |
| G-4 | 2-Pyridineethanol (manufactured by Tokyo Chemical Industry Co., Ltd.) |

TABLE 3

| No. | Electrophile |
|---|---|
| H-1 | 2-Bromoethanol (manufactured by Tokyo Chemical Industry Co., |
| | Ltd.) |
| H-2 | 6-Bromo-1-hexanol (manufactured by Tokyo Chemical Industry Co., |
| | Ltd.) |
| H-3 | 8-Bromo-1-octanol (manufactured by Tokyo Chemical Industry Co., |
| | Ltd.) |

TABLE 4

| No. | Ion-exchange Salt |
|---|---|
| I-1 | Potassium N,N-bis(fluorosulfonyl)imide (manufactured by |
| | Mitsubishi Materials Electronic Chemicals Co., Ltd.) |
| I-2 | LiTFSI (manufactured by Tokyo Chemical Industry Co., Ltd.) |

### (Synthesis of Ionic Conductive Agent A-2)

To a flask equipped with a Dimroth condenser, 6.1 g (0.09 mol) of G-1 (imidazole; manufactured by Tokyo Chemical Industry Co., Ltd.) as a nucleophile, 23.7 g (0.14 mol) of H-2 (6-bromo-1-hexanol; manufactured by Tokyo Chemical Industry Co., Ltd.) as an electrophile, 25 g (0.18 mol) of potassium carbonate (manufactured by Kanto Chemical Co., Inc.), and 200 ml of acetone were added, and the resulting mixture was heated under reflux overnight. After the reaction, the reaction solution was filtered, the solvent of the filtrate was distilled off under reduced pressure, and the residue was then purified by silica gel column chromatography (ethyl acetate) to obtain a compound resulting from tertiarization of the nucleophile.

Subsequently, the obtained compound was dissolved in 50 ml of dichloromethane, and 17.5 g (0.14 mol) of H-1 (2-bromoethanol; manufactured by Tokyo Chemical Industry Co., Ltd.) as an electrophile was added thereto, followed by heating under reflux at 40° C. for 18 hours. After the reaction, the solvent was distilled off under reduced pressure, and the residue was washed with diethyl ether and dried to obtain a quaternized ionic conductive agent precursor as a white powder.

Subsequently, to set the anion as a target anion, the whole amount of the obtained ionic conductive agent precursor was dissolved in 100 ml of methanol at room temperature. With stirring the solution, 19.3 g of ion-exchange salt I-1 (potassium N,N-bis(fluorosulfonyl)imide; manufactured by Mitsubishi Materials Electronic Chemicals Co., Ltd.) dissolved in 50 ml of pure water was added thereto, followed by stirring at room temperature for 24 hours. After the reaction, methanol was distilled off under reduced pressure, the resultant was separated with dichloromethane/water, the organic layer was collected and further washed twice with water. The solvent was then distilled off under reduced pressure, and the resultant was dried to obtain an ionic conductive agent A-2 as a white powder.

### (Synthesis of Ionic Conductive Agent A-3)

An ionic conductive agent A-3 was obtained in the same manner as in the synthesis of ionic conductive agent A-2, except that the types and blending amounts of the nucleophile, electrophile used as raw materials were changed as shown in Table 5.

TABLE 5

| | | | Electrophile for | | Electrophile for | | | |
|---|---|---|---|---|---|---|---|---|
| Ionic | Nucleophile | | Tertiarization | | Quaternization | | Ion-exchange Salt | |
| Conductive | | Addition | | Addition | | Addition | | Addition |
| Agent No. | No. | Amount (g) | No. | Amount (g) | No. | Amount (g) | No. | Amount (g) |
| A-2 | G-1 | 6.1 | H-2 | 23.7 | H-1 | 17.5 | I-1 | 19.3 |
| A-3 | G-1 | 6.1 | H-3 | 25.3 | H-1 | 17.5 | I-1 | 19.3 |

Table 6 shows the basic skeletons of the obtained ionic conductive agents. Besides, Table 7 shows the anion species, the number of hydroxyl groups, and the structures of the substituents.

TABLE 6

| No. | Structural Formula |
|---|---|
| (A) | 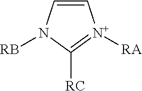 |
| (B) | 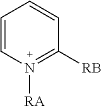 |

TABLE 7

| | | | Number | | | |
|---|---|---|---|---|---|---|
| Ionic | | | of | | | |
| Conductive | Structural | | Hydroxyl | Substituent | | |
| Agent No. | Formula | Anion | Groups | RA | RB | RC |
| A-1 | (A) | (FSO₂)₂N- | 2 | —CH₂CH₂OH | —CH₂CH₂OH | —H |
| A-2 | (A) | (FSO₂)₂N- | 2 | —(CH₂)₆OH | —CH₂CH₂OH | —H |
| A-3 | (A) | (FSO₂)₂N- | 2 | —(CH₂)₈OH | —CH₂CH₂OH | —H |
| A-4 | (A) | (FSO₂)₂N- | 2 | —(CH₂)₈OH | —(CH₂)₈OH | —H |
| A-5 | (A) | (FSO₂)₂N | 1 | —CH₂CH₂OH | —CH3 | —H |
| A-6 | (A) | (FSO₂)₂N | 3 | —CH₂CH₂OH | —CH₂CH₂OH | —CH₂CH₂OH |
| A-7 | (B) | (FSO₂)₂N- | 2 | —CH₂CH₂OH | —CH₂CH₂OH | — |
| AH-1 | (A) | (CF₃SO₂)₂N- | 2 | —CH₂CH₂OH | —CH₂CH₂OH | —H |

### <Synthesis of Hydroxyl-Terminated Urethane Prepolymer>

### (Synthesis of Hydroxyl-Terminated Urethane Prepolymer B-1)

Under a nitrogen atmosphere, 100 parts by mass of polypropylene glycol (trade name: Sannix GP-600, manufactured by Sanyo Chemical Industries, Ltd.) and 6.3 parts by mass of monomeric MDI (trade name: Millionate MT, manufactured by Tosoh Corporation) were reacted by heating and stirring at 90° C. for 3 hours. Thereafter, methyl ethyl ketone (MEK) was added to the resulting reaction product to prepare a hydroxyl-terminated urethane prepolymer B-1 having a solid content of 50.5% and a hydroxyl value of 20.2 mgKOH/g.

### <Synthesis of Isocyanate-Terminated Prepolymer>

### (Synthesis of Isocyanate-Terminated Prepolymer C-1)

Under a nitrogen atmosphere, 100 parts by mass of polypropylene glycol (trade name: Sannix GP-600, manufactured by Sanyo Chemical Industries, Ltd.) was gradually added dropwise to 38 parts by mass of polymeric MDI (trade name: Millionate MR-200, manufactured by Tosoh Corporation) in a reaction vessel with the temperature within the reaction vessel maintained at 65° C. After completion of the dropwise addition, the resultant mixture was allowed to react at 65° C. for 2 hours to obtain a reaction mixture.

The thus obtained reaction mixture was cooled to room temperature and diluted with methyl ethyl ketone (MEK) to obtain a solution of isocyanate-terminated prepolymer C-1 having a solid content of 64.6% and an isocyanate group content of 5.4%.

### <Preparation of Impregnating Liquid>

Materials shown in Table 8 below were dissolved and mixed as components for an impregnating liquid to be used in an impregnation treatment. The structural formulae of acrylic monomers J-1 to J-5 and JH-1 to JH5 shown in Table 8 were as follows.

TABLE 8

| | Acrylic Monomer | | | | | Initiator | | | |
|---|---|---|---|---|---|---|---|---|---|
| Impregnating | | Structural | | | | Trade Name, | | Solvent | |
| Liquid | No. | Formula | Parts | Trade Name | Manufacturer | Manufacturer | Parts | Name | Parts |
| G-1 | J-1 | (3) | 6 | Propane-1,3-diyl | Sigma | IRGACURE184, | 0.2 | MEK | 100 |
| | | | | diacrylate | Aldrich | BASF Japan Ltd. | | | |
| G-2 | J-2 | (3) | 6 | 1,6-Hexanediol | Sigma | | | | |
| | | | | diacrylate | Aldrich | | | | |
| G-3 | J-3 | (4) | 6 | TMPTA | Daicel-Allnex | | | | |
| | | | | | Ltd. | | | | |
| G-4 | J-4 | (4) | 6 | Pentaerythritol | FUJIFILM | | | | |
| | | | | Triacrylate | Wako Pure | | | | |
| | | | | | Chemical | | | | |
| | | | | | Corporation | | | | |
| G-5 | J-5 | (5) | 6 | Pentaerythritol | Tokyo | | | | |
| | | | | Tetraacrylate | Chemical | | | | |
| | | | | | Industry Co., Ltd. | | | | |
| GH-1 | JH-1 | (3) | 6 | EBECRYL 145 | Daicel-Allnex | | | | |
| | | | | | Ltd. | | | | |
| GH-2 | JH-2 | (3) | 6 | EBECRYL 11 | Daicel-Allnex | | | | |
| | | | | | Ltd. | | | | |
| GH-3 | JH-3 | (4) | 6 | EBECRYL 160S | Daicel-Allnex | | | | |
| | | | | | Ltd. | | | | |
| GH-4 | JH-4 | (3) | 6 | NK Ester 9G | Shin- | | | | |
| | | | | | Nakamura | | | | |
| | | | | | Chemical Co., Ltd. | | | | |
| GH-5 | JH-5 | (3) | 6 | NK Ester 14G | Shin- | | | | |
| | | | | | Nakamura | | | | |
| | | | | | Chemical Co., Ltd. | | | | |

(J-1) 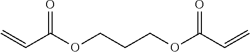
(J-2) 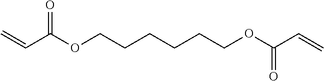 [SMILES: C=CC(=O)OCCCCCCOC(=O)C=C]
(J-3) 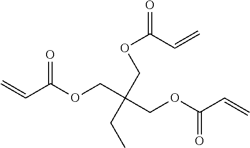 [SMILES: C=CC(=O)OCC(CC)(COC(=O)C=C)COC(=O)C=C]
(J-4) 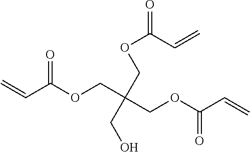 [SMILES: C=CC(=O)OCC(CO)(COC(=O)C=C)COC(=O)C=C]
(J-5) 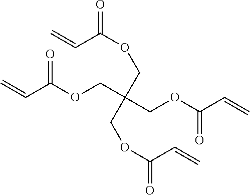 [SMILES: C=CC(=O)OCC(COC(=O)C=C)(COC(=O)C=C)COC(=O)C=C]
(JH-1) 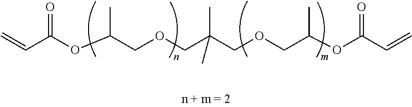
(JH-2) 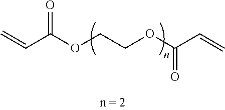
(JH-3) 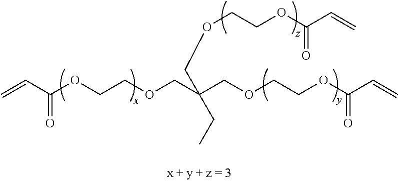
(JH-4) 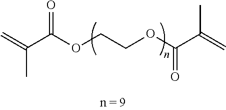
(JH-5)

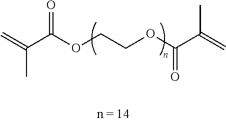

wherein n, m, x, y and z each independently represent a degree of polymerization.

### <Preparation of Conductive Layer-Forming Coating Material>

### (Preparation of Conductive Layer-Forming Coating Material E-1)

As materials for the conductive layer, the following materials were mixed by stirring.
Hydroxyl-terminated urethane prepolymer B-1:130 parts by mass
Ethylene oxide/propylene oxide-based monool (trade name: Newpol HB-600, manufactured by Sanyo Chemical Industries, Ltd.): 5 parts by mass
Isocyanate-terminated urethane prepolymer C-1:55 parts by mass
Ionic conductive agent A-1:0.1 parts by mass
Carbon black (1) (trade name: SUNBLACK X15, manufactured by Asahi Carbon Co., Ltd.): 18 parts by mass
Carbon black (2) (trade name: SUNBLACK X55, manufactured by Asahi Carbon Co., Ltd.): 5 parts by mass
Silicone oil (trade name: TSF4445, manufactured by Momentive Performance Materials Inc.): 1 part by mass
Urethane resin particle (trade name: Daimic Beads UCN-5190D, manufactured by Dainichiseika Color & Chemicals Mfg. Co., Ltd.): 82.5 parts by mass

Next, methyl ethyl ketone was added to the resultant such that the total solid content ratio became 30% by mass, and the resulting mixture was blended with a sand mill. Besides, the viscosity was adjusted to 10 cps to 13 cps with methyl ethyl ketone to prepare a conductive layer-forming coating material E-1.

### <Toner>

### (Production Example of Toner L-1)

### <Preparation of Resin Particle Dispersion 1>

78.0 parts of styrene, 20.7 parts of butyl acrylate, 1.3 parts of acrylic acid as a carboxyl group-imparting monomer, and 3.2 parts of n-lauryl mercaptan were mixed and dissolved. To the resultant solution, the whole amount of an aqueous solution, which was prepared by dissolving 2.0 parts of sodium linear alkylbenzene sulfonate (product name: Neogen RK, manufactured by Dai-ichi Kogyo Seiyaku Co., Ltd.) in 150 parts of ion-exchanged water, was added and dispersed.

With the resultant solution slowly stirred for 10 minutes, an aqueous solution of 0.3 parts of potassium persulfate and 10 parts of ion-exchanged water was added thereto. After purging with nitrogen, emulsion polymerization was carried out at 70° C. for 6 hours. After completion of the polymerization, the resultant reaction solution was cooled to room temperature, and ion-exchanged water was added thereto to obtain a resin particle dispersion 1 having a solid content concentration of 12.5% by mass and a volume-based median diameter of 0.2 μm.

### <Preparation of Release Agent Dispersion 1>

A mixture was prepared by mixing 100 parts of a release agent (behenyl behenate, melting point: 72.1° C.) and 15 parts of an aliphatic alcohol alkylene oxide adduct with 385 parts of ion-exchanged water, and the mixture was dispersed for approximately 1 hour with a wet-type jet mill JN100 (manufactured by Jokoh Co., Ltd.) to obtain a release agent dispersion 1. The concentration of the release agent dispersion 1 was 20% by mass.

### <Preparation of Colorant Dispersion 1>

A mixture was prepared by mixing 100 parts of carbon black “Nipex35 (manufactured by Orion Engineered Carbons S.A.)” as a colorant and 15 parts of an aliphatic alcohol alkylene oxide adduct with 885 parts of ion-exchanged water, and the mixture was dispersed for approximately 1 hour with the wet-type jet mill JN100 to obtain a colorant dispersion 1.

### <Production Example of Toner Core Particle Dispersion 1>

### (Dispersion Step)

265 parts of the resin particle dispersion 1, 10 parts of the release agent dispersion 1, 10 parts of the colorant dispersion 1, 2.9 parts of an aliphatic alcohol alkylene oxide adduct, and 0.6 parts of sodium linear alkylbenzene sulfonate (Neogen RK) were dispersed with a homogenizer (Ultra-Turrax T50, manufactured by IKA). The internal temperature of the vessel was adjusted, under stirring, to 30° C., and the pH was adjusted to 8.0 by adding a 1 mol/L aqueous sodium hydroxide solution.

### (Aggregation Step)

An aqueous solution prepared by dissolving 0.08 parts of aluminum chloride in 10 parts of ion-exchanged water was added, as an aggregating agent, over 10 minutes under stirring at 30° C. After leaving the resultant mixture for 3 minutes, the temperature was raised to 50° C. to allow formation of associated particles. In this state, the particle size of the associated particle was measured with a “Coulter Counter Multisizer 3” ((R), manufactured by Beckman Coulter, Inc.). When the number-average particle size reached 6.1 μm, 0.9 parts of sodium chloride and 5.0 parts of an aliphatic alcohol were added to terminate the particle growth.

The pH was adjusted to 9.0 by adding a 1 mol/L aqueous sodium hydroxide solution, and then the temperature was raised to 95° C. to cause spheroidization of the aggregated particles. When the average circularity reached 0.980, the temperature was started to be decreased to room temperature, and thus, a toner core particle dispersion 1 was obtained.

### <Production Example of Monomer Dispersion 1 Containing Silica and Binding Component>

100 parts of styrene, 20 parts of methacryloxypropyltrimethoxysilane, and 100 parts of colloidal silica were dispersed with a homogenizer (Ultra-Turrax T50, manufactured by IKA), and with the internal temperature of the vessel adjusted to 25° C., the resultant mixture was stirred for 1 hour to obtain a monomer dispersion 1 containing silica and a binder component.

Next, production examples of toners will be described.

### (Production Example of Toner L-1)

To 100 parts of the toner core particle dispersion 1, 2.75 parts of the monomer dispersion 1 obtained by the above method and 0.005 parts of potassium persulfate were added, and with the internal temperature of the vessel adjusted to 90° C., the resultant mixture was stirred for 2 hours with a Fullzone impeller to obtain a toner particle dispersion 1.

Hydrochloric acid was added to the obtained toner particle dispersion 1 to adjust the pH to 1.5 or less, and after the mixture was stirred and allowed to stand for 1 hour, solid-liquid separation was performed with a pressure filter to obtain a toner cake. This toner cake was reslurried with ion-exchanged water to obtain a dispersion again, and then solid-liquid separation was performed with the aforementioned filter. The reslurrying and solid-liquid separation were repeated until the electrical conductivity of the filtrate reached 5.0 μS/cm or less, and finally, solid-liquid separation was performed to obtain a toner cake. The thus obtained toner cake was dried and further classified with a classifier to obtain a toner particle 1. The number average particle size of the primary particle of the toner particle 1 was 6.0 μm.

The obtained toner particle 1 was sieved through a mesh with an opening of 75 μm to obtain a toner L-1.

### (Production Example of Toner L-2)

### [Production of Magnetic Material 1]

An aqueous solution containing ferrous hydroxide was prepared by mixing, with an aqueous ferrous sulfate solution sodium, a caustic soda solution in an amount of 1.00 to 1.10 equivalents relative to iron element, P₂O₅ in an amount of 0.15% by mass in terms of phosphorus element relative to the iron element, and SiO₂ in an amount of 0.50% by mass in terms of silicon element relative to the iron element. The pH of the aqueous solution was adjusted to 8.0, and an oxidation reaction was carried out at 85° C. with air blown thereinto to prepare a slurry containing a seed crystal.

Next, an aqueous ferrous sulfate solution in an amount of 0.90 to 1.20 equivalents relative to the initial amount of alkali (the sodium component of caustic soda) was added to this slurry, and with the slurry maintained at pH 7.6, the oxidation reaction was allowed to proceed while blowing air thereinto to obtain a water-containing slurry containing magnetic iron oxide. After filtration and washing, the water-containing slurry was temporarily collected. At this time, a small amount of a water-containing sample was taken from the slurry to measure the water content.

Next, this water-containing sample was introduced into another aqueous medium without drying, the magnetic iron oxide was redispersed with a pin mill under stirring and circulating the slurry, and the pH of the resulting redispersion therein was adjusted to approximately 4.8. Then, 1.6 parts by mass of a n-hexyltrimethoxysilane coupling agent was added, under stirring, per 100 parts by mass of the magnetic iron oxide to carry out hydrolysis.

The amount of magnetic iron oxide was calculated as a value obtained by subtracting the water content from the water-containing sample. Thereafter, stirring was sufficiently performed, and the surface treatment with a silane coupling agent was carried out after adjusting the pH of the dispersion to 8.6. The resultant hydrophobic magnetic material was filtered with a filter press, washed with a large amount of water, and then dried at 100° C. for 15 minutes and at 90° C. for 30 minutes. The thus obtained particles were subjected to a pulverization process to obtain a magnetic material 1 having a volume average particle size of 0.21 μm.

### [Production of Polyester Resin 1]

Materials shown in Table 9 below were placed in a reaction vessel equipped with a condenser, a stirrer, and a nitrogen inlet tube, and reacted at 230° C. for 10 hours with distilling off water generated under a nitrogen stream. Subsequently, the reaction was continued under a reduced pressure of 5 to 20 mmHg, and when the acid value reached 2 mgKOH/g or less, the resultant was cooled to 180° C., and 10 parts by mass of trimellitic anhydride was added thereto. After performing reaction for 2 hours under sealed normal pressure, the reaction product was taken out, cooled to room temperature, and pulverized to obtain a polyester resin 1. The polyester resin 1 had a main peak molecular weight (Mp) of 10500 as measured by gel permeation chromatography (GPC).

TABLE 9

| Material | Parts by Mass |
|---|---|
| 2-mol Propylene Oxide Adduct of Bisphenol A | 75 |
| 3-mol Propylene Oxide Adduct of Bisphenol A | 25 |
| Terephthalic Acid | 100 |
| Titanium-based Catalyst (titanium | 0.25 |
| dihydroxybis(triethanolaminate)) | |

### [Production of Developer Particles 1]

A vessel was charged with 720 parts by mass of ion-exchanged water and 450 parts by mass of a 0.1 M Na₃PO₄ aqueous solution, and the resultant was heated to 60° C., and then, 67.7 parts by mass of a 1.0 M CaCl₂) aqueous solution was added thereto to obtain an aqueous medium containing a dispersion stabilizer. Separately, materials shown in “Component 1” section in Table 10 below were homogeneously dispersed and mixed with Attritor (trade name, manufactured by Mitsui Miike Machinery Co., Ltd.) to obtain a polymerizable monomer composition.

This polymerizable monomer composition was heated to 60° C., and a material shown in “Component 2” section in Table 10 below was added thereto to be mixed and dissolved. Subsequently, a material shown in “Component 3” section was added as a polymerization initiator to be mixed and dissolved to obtain a developer composition.

TABLE 10

| | | Parts by |
|---|---|---|
| | Material | Mass |
| Component | Styrene | 78 |
| 1 | n-Butyl Acrylate | 22 |
| | Divinyl Benzene | 0.6 |
| | Iron Complex of Monoazo Dye | 3 |
| | (T-77: manufactured | |
| | by Hodogaya Chemical Co., Ltd.) | |
| | Magnetic Material 1 | 90 |
| | Polyester Resin 1 | 5 |
| Component | Fischer-Tropsch wax (melting point: 74° C., | 15 |
| 2 | number average molecular weight: 500) | |
| Component | Dilauroyl Peroxide | 7 |
| 3 | | |

The developer composition was introduced into the aqueous medium, and the resultant was granulated by stirring at 12000 rpm for 10 minutes with a TK Homomixer (trade name, manufactured by Tokushu Kika Kogyo Co., Ltd.) at 60° C. under a N₂ atmosphere. Thereafter, the reaction was carried out at 74° C. for 6 hours under stirring with a paddle impeller. After completion of the reaction, the resultant suspension was cooled, and hydrochloric acid was added thereto for washing, and the resultant was filtered and dried to obtain a developer particle 1. The thus obtained magnetic developer, that is, the developer particle 1, had a weight average particle size of 8.0 μm and an average circularity of 0.938.

### [Production of Developer L-2]

Materials shown in Table 11 below were charged into a Henschel Mixer FM10C (manufactured by Mitsui Miike Machinery Co., Ltd.) and mixed for 5 minutes at a constant rotation speed of 4000 rpm. After the mixing process, coarse particles and the like were removed with a circular vibrating sieve equipped with a screen having a diameter of 500 mm and an opening of 75 μm to obtain a toner L-2.

TABLE 11

| | Parts by |
|---|---|
| Material | Mass |
| Toner Particle 1 | 100 |
| Silica Fine Particle 1 | 1.3 |
| (Number average particle size of primary particle of silica material: | |
| 7 nm, BET Specific Surface Area: 300 m²/g, | |
| Carbon-based Immobilization Rate of Silicone Oil: 98%, | |
| Apparent Density: 25 g/L, | |
| Number Average Particle Size of Primary Particle of Silica | |
| Fine Particle after Treatment: 8 nm) | |

### <<Developing Roller>>

### <Developing Roller GZ-1>

First, the elastic roller K-1 produced as described above was immersed in the conductive layer-forming coating material E-1 to form a coating film of the coating material on the surface of the elastic layer, and the film was air dried. The resultant was subjected to a heat treatment at a temperature of 150° C. for 1 hour to provide a conductive layer having a thickness of approximately 15 μm on the outer periphery of the elastic layer, and thus, a developing roller precursor was produced.

Subsequently, the precursor was subjected to a treatment of immersion in the impregnating liquid G-1 for 2 seconds. Thereafter, the resultant was air dried at room temperature for 30 minutes, and then dried at 90° C. for 1 hour to evaporate the solvent. The dried elastic roller was irradiated with ultraviolet rays, while being rotated, such that the cumulative light intensity became 15000 mJ/cm², for curing the (meth)acrylic component. A high-pressure mercury lamp (trade name: Handy-type UV Curing System, manufactured by Mario Network Co., Ltd.) was used as the ultraviolet irradiation apparatus. Thus, a developing roller GZ-1 to be used in Example was obtained.

### Examples and Comparative Examples

Developing rollers according to the following Examples and Comparative Examples were obtained in the same manner as the above-described developing roller, except that conductive layer-forming coating materials shown in Table 12 were used.

TABLE 12

| | | | | | Amount of | Proportion of | |
|---|---|---|---|---|---|---|---|
| | | | | | Anionic | First and | |
| | | | | | Components | Second | |
| | | | | | Contained in | Resins to | |
| | | | | | Conductive | Resins | Proportion of |
| | | | | | Layer per 100 | Contained in | Bis(fluorosulfony1)imide |
| | | | | | Parts by Mass | First Region | Anion in Anionic |
| | Ionic Conductive | | Impregnating | | of Total of First | of | Components to Anionic |
| | Agent | | Liquid | | and Second | Conductive | Components Contained |
| Roller | | Contained | | Contained | Resins (Parts by | Layer | in Conductive Layer |
| No. | No. | Structure | No. | Structure | Mass) | (Mass %) | (Mass %) |
| GZ-1 | A-1 | C-1 | G-1 | C-3 | 0.1 | 99 | 100 |
| GZ-2 | A-1 | C-1 | G-2 | C-3 | 0.1 | 99 | 100 |
| GZ-3 | A-1 | C-1 | G-3 | C-4 | 0.1 | 99 | 100 |
| GZ-4 | A-1 | C-1 | G-4 | C-4 | 0.1 | 99 | 100 |
| GZ-5 | A-1 | C-1 | G-5 | C-5 | 0.1 | 99 | 100 |
| GZ-6 | A-2 | C-1 | G-1 | C-3 | 0.1 | 99 | 100 |
| GZ-7 | A-2 | C-1 | G-2 | C-3 | 0.1 | 99 | 100 |
| GZ-8 | A-2 | C-1 | G-3 | C-4 | 0.1 | 99 | 100 |
| GZ-9 | A-3 | C-1 | G-1 | C-3 | 0.1 | 99 | 100 |
| GZ-10 | A-3 | C-1 | G-2 | C-3 | 0.1 | 99 | 100 |
| GZ-11 | A-3 | C-1 | G-3 | C-4 | 0.1 | 99 | 100 |
| GZ-12 | A-4 | C-1 | G-1 | C-3 | 0.1 | 99 | 100 |
| GZ-13 | A-4 | C-1 | G-2 | C-3 | 0.1 | 99 | 100 |
| GZ-14 | A-4 | C-1 | G-3 | C-4 | 0.1 | 99 | 100 |
| GZ-15 | A-5 | C-1 | G-1 | C-3 | 0.1 | 99 | 100 |
| GZ-16 | A-5 | C-1 | G-2 | C-3 | 0.1 | 99 | 100 |
| GZ-17 | A-5 | C-1 | G-3 | C-4 | 0.1 | 99 | 100 |
| GZ-18 | A-6 | C-1 | G-1 | C-3 | 0.1 | 99 | 100 |
| GZ-19 | A-6 | C-1 | G-2 | C-3 | 0.1 | 99 | 100 |
| GZ-20 | A-6 | C-1 | G-3 | C-4 | 0.1 | 99 | 100 |
| GZ-21 | A-7 | C-2 | G-1 | C-3 | 0.1 | 99 | 100 |
| GZ-22 | A-7 | C-2 | G-2 | C-3 | 0.1 | 99 | 100 |
| GZ-23 | A-7 | C-2 | G-3 | C-4 | 0.1 | 99 | 100 |
| GZH-1 | A-1 | C-1 | GH-1 | C-3 | 0.1 | 99 | 100 |
| GZH-2 | A-1 | C-1 | GH-2 | C-3 | 0.1 | 99 | 100 |
| GZH-3 | A-1 | C-1 | GH-3 | C-4 | 0.1 | 99 | 100 |
| GZH-4 | A-1 | C-1 | GH-4 | C-3 | 0.1 | 99 | 100 |
| GZH-5 | A-1 | C-1 | GH-5 | C-3 | 0.1 | 99 | 100 |
| GZH-6 | AH-1 | C-1 | G-1 | C-3 | 0.1 | 99 | 0 |

The obtained conductive rollers and developer according to Examples were evaluated for the following items. The results are shown in Table 13.

### <Analysis of Final Roller>

### [Measurement of T1, T2, T3, A1, and A2]

By the above-described microsampling mass spectrometry, thermal chromatograms were obtained for the first region extending from the outer surface of the developing roller to a depth of 0.1 μm, the second region having a thickness of 0.1 μm extending from the back surface toward the front surface of the conductive layer, and the third region at a depth of 1.0 μm or more and 1.1 μm or less from the surface.

From the obtained thermal chromatograms, the peak top temperatures T1, T2, and T3 in the thermal chromatograms derived from the cross-linked urethane resin respectively in the first region, the second region, and the third region were determined.

Besides, the peak top temperature A1 in the thermal chromatogram derived from the cross-linked acrylic resin in the first region was obtained. Furthermore, the peak top temperature A2 in the thermal chromatogram derived from the cross-linked acrylic resin measured in the second sample, which was prepared by decomposing the cross-linked urethane resin contained in the sample sampled from the first region, was obtained.

Samples from the respective regions were collected by a microsampling method with FIB-SEM (trade name: NVision 40, manufactured by SII Nanotechnology Inc.).

Specifically, first, a cut was made from the surface of the developing roller toward the substrate with a razor, and a rubber piece in which the cross-sections of the conductive layer and the intermediate layer were exposed was cut out. The rubber piece was placed on an SEM sample table such that the roller cross-section faced upward, and a sampling probe was fixed at a position corresponding to the roller surface of the rubber piece. Furthermore, a cutting process using FIB was performed at a position 0.1 μm inward from the surface corresponding to the roller surface, and thus, a sample of the first region was collected.

For the second region, a cutting process using FIB was performed at a position 1.0 μm toward the front surface from the interface between the back surface of the conductive layer and the intermediate layer. A sampling probe was fixed to the resulting cut surface, and a cutting process was performed with FIB at a position 0.1 μm inward from the cut surface, and thus, a sample of the second region was collected.

For the third region, the third region was exposed by performing a cutting process using FIB at a position 1.0 μm inward from the surface corresponding to the roller surface in a rubber piece similar to the one described above. A sampling probe was fixed to the exposed surface, and a cutting process was performed with FIB at a position 0.1 μm inward from the exposed surface, and thus, a sample of the third region was collected.

In all of the cutting processes, the acceleration voltage of the FIB was set to 30 kV, and the beam current was set to 27 mA.

### [Pyridine Degradation Method]

A pyridine degradation method is a method for selectively decomposing a urethane bond. By performing the pyridine degradation method on a sample having an IPN structure of the cross-linked acrylic resin and the cross-linked urethane resin, the cross-linked acrylic resin can be obtained after removing the structure derived from the cross-linked urethane.

From the thus obtained cross-linked acrylic resin, it is possible to capture change in the peak temperature in the thermal chromatogram depending on the presence or absence of the IPN structure. Specifically, the pyridine degradation method was performed as follows.

A sample with a thickness of 0.1 μm was cut out from the surface of the developing roller with a microtome, and 500 mg of the sample was collected. To the obtained sample, 0.5 mL of a mixture of pyridine (manufactured by Wako Pure Chemical Industries, Ltd.) and water at a ratio of 3:1 was added, and the resultant mixture was then heated at 130° C. for 15 hours in a sealed fluororesin (Teflon®) container with a stainless steel jacket to perform decomposition. Pyridine was removed by subjecting the resulting decomposition product to a decompression treatment. By using the sample thus obtained, the above-described microsampling mass spectrometry was performed to obtain the value of A2.

### [Measurement of α, β, and γ]

The α, β, and γ were calculated with ESCA as follows. The elemental analysis of the second sample was performed with the following apparatus under the following conditions:
Measurement apparatus: Quantum2000 (trade name, manufactured by ULVAC-PHI, Inc.)
X-ray source: monochromatic AlKa
X-ray setting: 100 μmφ (25 W (15 KV))
Photoelectron take-off angle: 45 degrees
Neutralization condition: combined use of neutralization and ion guns
Analysis region: 300×200 μm
Pass Energy: 58.70 eV
Step size: 1.25 eV
Analysis software: Multipak (ULVAC-PHI, Inc.)

Here, the C (1s) peak (binding energy (B.E.) of 286.0 to 287.0 eV) was used for calculation of a quantitative value of carbon atom adjacent to oxygen atom (carbon atom of C—O bond), the C (1s) peak (B.E. of 288.0 to 290.0 eV) was used for calculation of a quantitative value of carbonyl carbon atom (carbon atom of C═O bond), and the S (2p3/2) peak (B.E. of 166.0 to 170.0 eV) was used for calculation of a quantitative value of sulfur atom, respectively.

### <Evaluation of Fluctuation in Roller Resistance Value>

The roller resistance value was measured using a conductive roller that had been left in a 0° C. environment for 6 hours or more.

### [Measurement of Initial Roller Resistance]

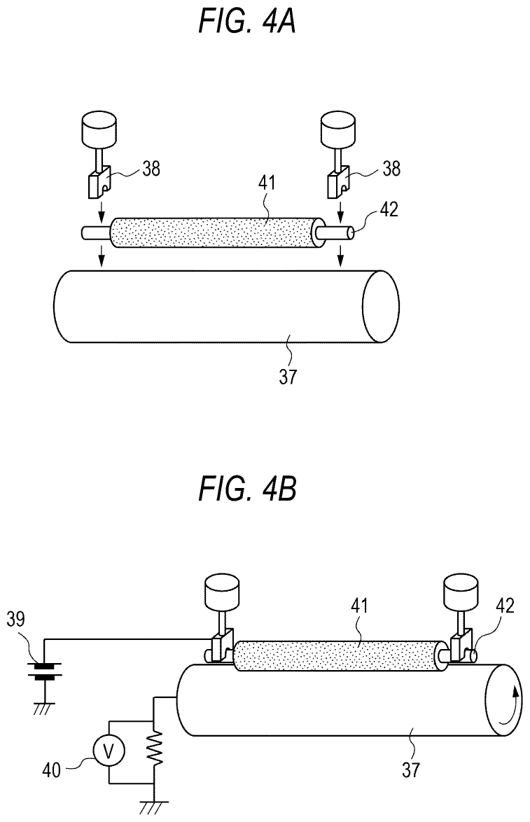

FIGS. 4A and 4B are schematic diagrams illustrating the structure of a jig for evaluating the fluctuation in the resistance value of a roller of the present disclosure. In FIG. 4A, in a 0° C. environment, both ends of a conductive shaft 42 were pressed with a load of 4.9 N each via conductive bearings 38, and a cylindrical metal member 37 having a diameter of 24 mm was rotated at a surface speed of 50 mm/sec, and thus, a conductive roller 41 was rotated to follow the cylindrical metal member.

Next, in FIG. 4B, a voltage of 50 V was applied by a high-voltage power supply 39, and the potential difference between both ends of a resistor having a known electrical resistance (the electrical resistance of which is lower than that of the conductive roller by two orders of magnitude or more) disposed between the cylindrical metal member 37 and the ground was measured. A voltmeter 40 (189 TRUE RMS MULTIMETER, manufactured by FLUKE Corporation) was used for the measurement of the potential difference.

From the measured potential difference and the electrical resistance of the resistor, the current flowing to the cylindrical metal member through the conductive roller 41 was obtained by calculation. The electrical resistance value of the conductive roller 41 was obtained by dividing the applied voltage of 50 V by the obtained current.

Here, the potential difference was measured by sampling for 3 seconds starting from 2 seconds after the voltage application, and a value calculated from the average value thereof was determined as the initial roller resistance value.

[Measurement of Roller Resistance after Evaluation]

Immediately after performing ghosting evaluation described later, the roller was taken out, and the roller resistance after energization was measured in a 0° C. environment.

### [Energization Degradation]

A value obtained by dividing the roller resistance value after evaluation by the initial roller resistance value (roller resistance value after evaluation/initial roller resistance value) was used as an index of energization degradation.

### <<Developing Roller>>

### [Ghosting Evaluation]

Next, the conductive roller, for which the initial roller resistance had been measured as described above, was left in a 0° C. environment for 6 hours or more, and then the following evaluation was performed.

A laser printer (trade name: LBP7700C; manufactured by CANON KABUSHIKI KAISHA) having the structure illustrated in FIG. 3 was installed in a 0° C. environment, and the conductive roller used as the electrophotographic member of each of the Examples was installed as a developing roller, and ghosting evaluation was performed.

First, a normal halftone image (image H) was printed using the toner L-1 or L-2. Next, as an image pattern, a 15 mm square solid black image was printed at the leading edge and then a full-surface halftone image (image G) was printed thereafter within a single sheet.

A density ratio H/G between a density H in the obtained image H, and a density G, in the image G, of the halftone portion obtained through the first rotation of the developing roller after the solid black pattern were calculated, and density unevenness occurring in the halftone portion through the cycles of the developing roller serving as a toner carrier was visually evaluated, so as to determine ghosting resistance as follows:

$$A : 0.95 \leq H / G \leq 1. ( no ghosting observed )$$

$$B : 0.9 \leq H / G \leq 0.95 ( very slight ghosting observed )$$

$$C : H / G < 0.9 ( c onspicuous ghosting observed )$$

TABLE 13

| | | | Ionic | | | | | | | | | |
|---|---|---|---|---|---|---|---|---|---|---|---|---|
| | Comparative | Developing | Conductive | Impregnating | | | | | | | | |
| Example | Example | Roller No. | Agent No. | Liquid No. | Toner | A1 | A2 | α/β | T1 | T2 | T3 | α/γ |
| 1 | | GZ-1 | A-1 | G-1 | L-1 | 395.4 | 392.3 | 84.6 | 382.3 | 378.2 | 379.1 | 1.0 |
| 2 | | GZ-2 | A-1 | G-2 | L-1 | 395.4 | 392.3 | 74.2 | 382.3 | 378.2 | 379.1 | 1.0 |
| 3 | | GZ-3 | A-1 | G-3 | L-1 | 396.1 | 393.0 | 97.1 | 383.1 | 379.2 | 380.3 | 1.0 |
| 4 | | GZ-4 | A-1 | G-4 | L-1 | 396.1 | 393.0 | 201.0 | 383.1 | 379.2 | 380.3 | 1.3 |
| 5 | | GZ-5 | A-1 | G-5 | L-1 | 397.0 | 394.1 | 265.5 | 385.4 | 382.5 | 383.3 | 1.0 |
| 6 | | GZ-6 | A-2 | G-1 | L-1 | 395.4 | 392.3 | 98.7 | 382.3 | 378.2 | 379.1 | 1.0 |
| 7 | | GZ-7 | A-2 | G-2 | L-1 | 395.4 | 392.3 | 86.5 | 382.3 | 378.2 | 379.1 | 1.0 |
| 8 | | GZ-8 | A-2 | G-3 | L-1 | 396.1 | 393.0 | 113.3 | 383.1 | 379.2 | 380.3 | 1.0 |
| 9 | | GZ-9 | A-3 | G-1 | L-1 | 395.4 | 392.3 | 105.8 | 382.3 | 378.2 | 379.1 | 1.0 |
| 10 | | GZ-10 | A-3 | G-2 | L-1 | 395.4 | 392.3 | 92.7 | 382.3 | 378.2 | 379.1 | 1.0 |
| 11 | | GZ-11 | A-3 | G-3 | L-1 | 396.1 | 393.0 | 121.4 | 383.1 | 379.2 | 380.3 | 1.0 |
| 12 | | GZ-12 | A-4 | G-1 | L-1 | 395.4 | 392.3 | 126.9 | 382.3 | 378.2 | 379.1 | 1.0 |
| 13 | | GZ-13 | A-4 | G-2 | L-1 | 395.4 | 392.3 | 111.2 | 382.3 | 378.2 | 379.1 | 1.0 |
| 14 | | GZ-14 | A-4 | G-3 | L-1 | 396.1 | 393.0 | 145.6 | 383.1 | 379.2 | 380.3 | 1.0 |
| 15 | | GZ-15 | A-5 | G-1 | L-1 | 395.4 | 392.3 | 83.1 | 382.3 | 378.2 | 379.1 | 1.0 |
| 16 | | GZ-16 | A-5 | G-2 | L-1 | 395.4 | 392.3 | 72.9 | 382.3 | 378.2 | 379.1 | 1.0 |
| 17 | | GZ-17 | A-5 | G-3 | L-1 | 396.1 | 393.0 | 95.4 | 383.1 | 379.2 | 380.3 | 1.0 |
| 18 | | GZ-18 | A-6 | G-1 | L-1 | 395.4 | 392.3 | 95.7 | 382.3 | 378.2 | 379.1 | 1.0 |
| 19 | | GZ-19 | A-6 | G-2 | L-1 | 395.4 | 392.3 | 83.9 | 382.3 | 378.2 | 379.1 | 1.0 |
| 20 | | GZ-20 | A-6 | G-3 | L-1 | 396.1 | 393.0 | 109.8 | 383.1 | 379.2 | 380.3 | 1.0 |
| 21 | | GZ-21 | A-7 | G-1 | L-1 | 395.4 | 392.3 | 87.4 | 382.3 | 378.2 | 379.1 | 1.0 |
| 22 | | GZ-22 | A-7 | G-2 | L-1 | 395.4 | 392.3 | 76.6 | 382.3 | 378.2 | 379.1 | 1.0 |
| 23 | | GZ-23 | A-7 | G-3 | L-1 | 396.1 | 393.0 | 100.3 | 383.1 | 379.2 | 380.3 | 1.0 |
| 24 | | GZ-1 | A-1 | G-1 | L-2 | 395.4 | 392.3 | 84.6 | 382.3 | 378.2 | 379.1 | 1.0 |
| 25 | | GZ-2 | A-1 | G-2 | L-2 | 395.4 | 392.3 | 74.2 | 382.3 | 378.2 | 379.1 | 1.0 |
| 26 | | GZ-3 | A-1 | G-3 | L-2 | 396.1 | 393.0 | 97.1 | 383.1 | 379.2 | 380.3 | 1.0 |
| | 1 | GZH-1 | A-1 | GH-1 | L-1 | 395.4 | 392.3 | 427.2 | 382.3 | 378.2 | 379.1 | 3.0 |
| | 2 | GZH-2 | A-1 | GH-2 | L-1 | 395.4 | 392.3 | 1099.0 | 382.3 | 378.2 | 379.1 | 12.0 |
| | 3 | GZH-3 | A-1 | GH-3 | L-1 | 396.1 | 393.0 | 503.8 | 383.1 | 379.2 | 380.3 | 3.0 |
| | 4 | GZH-4 | A-1 | GH-4 | L-1 | 395.4 | 392.3 | 882.1 | 382.3 | 378.2 | 379.1 | 9.0 |
| | 5 | GZH-5 | A-1 | GH-5 | L-1 | 395.4 | 392.3 | 1088.9 | 382.3 | 378.2 | 379.1 | 14.0 |
| | 6 | GZH-6 | AH-1 | G-1 | L-1 | 395.4 | 392.3 | 553.9 | 382.3 | 378.2 | 379.1 | 3.0 |

| | | | Roller | | |
|---|---|---|---|---|---|
| | | Initial | Resistance | | |
| | | Roller | after | | |
| | Comparative | Resistance | Energization | Energization | |
| Example | Example | (52) | (2) | Degradation | Ghosting |
| 1 | | 4.5E+05 | 5.6E+05 | 1.24 | A |
| 2 | | 5.4E+05 | 6.8E+05 | 1.26 | A |
| 3 | | 6.1E+05 | 8.1E+05 | 1.33 | A |
| 4 | | 6.7E+05 | 9.0E+05 | 1.34 | A |
| 5 | | 7.4E+05 | 9.9E+05 | 1.34 | A |
| 6 | | 8.1E+05 | 1.1E+06 | 1.36 | A |
| 7 | | 8.9E+05 | 1.2E+06 | 1.35 | A |
| 8 | | 9.5E+05 | 1.3E+06 | 1.37 | A |
| 9 | | 1.1E+06 | 1.5E+06 | 1.36 | A |
| 10 | | 1.8E+06 | 2.4E+06 | 1.33 | A |
| 11 | | 2.1E+06 | 2.9E+06 | 1.38 | A |
| 12 | | 3.5E+06 | 4.8E+06 | 1.37 | A |
| 13 | | 4.2E+06 | 5.7E+06 | 1.36 | A |
| 14 | | 5.1E+06 | 7.0E+06 | 1.37 | A |
| 15 | | 6.3E+06 | 8.6E+06 | 1.37 | A |
| 16 | | 7.4E+06 | 1.0E+07 | 1.38 | A |
| 17 | | 8.2E+06 | 1.1E+07 | 1.38 | A |
| 18 | | 9.4E+06 | 1.3E+07 | 1.37 | A |
| 19 | | 1.0E+07 | 1.4E+07 | 1.39 | A |
| 20 | | 1.1E+07 | 1.5E+07 | 1.38 | A |
| 21 | | 3.5E+07 | 5.2E+07 | 1.49 | A |
| 22 | | 5.1E+07 | 7.5E+07 | 1.47 | A |
| 23 | | 7.4E+07 | 1.1E+08 | 1.46 | A |
| 24 | | 4.5E+05 | 5.6E+05 | 1.24 | B |
| 25 | | 5.4E+05 | 6.8E+05 | 1.26 | B |
| 26 | | 6.1E+05 | 8.1E+05 | 1.33 | B |
| | 1 | 1.2E+09 | 4.1E+09 | 3.42 | C |
| | 2 | 3.6E+09 | 1.5E+10 | 4.19 | C |
| | 3 | 4.1E+09 | 1.8E+10 | 4.41 | C |
| | 4 | 5.3E+09 | 2.6E+10 | 4.91 | C |
| | 5 | 7.7E+09 | 4.1E+10 | 5.32 | C |
| | 6 | 1.1E+10 | 7.5E+10 | 6.82 | C |

In the table, “E+number” represents the exponential notation of a numerical value. For example, “5.4 E+05” represents “5.4×10⁵” (the same applies hereinafter).

In the developing rollers of Examples and Comparative Examples shown in Table 13, it was confirmed by the analytical operation by the aforementioned pyridine decomposition method that the formula (1) was satisfied, and it was confirmed that an IPN structure was present in all of the developing rollers.

### <Discussion of Evaluation Results>

The electrophotographic members and the electrophotographic apparatuses of Examples 1 to 26 contained, in the conductive layers of the present disclosure, the compounds having the structure represented by the formula (C-1) or (C-2) of the present disclosure, contain, in the outermost surface, at least one of the structures represented by the formulae (C-3) to (C-5) of the present disclosure, and therefore, showed little rise in resistance after image output in a 0° C. environment, and sustained high image quality.

In particular, Examples 1 to 23 indicate that the use of a toner containing a specific structure results in even better ghosting resistance. This is presumed to be because the combination of the electrophotographic member and the toner caused favorable triboelectric charging, and hence the toner coat layer on the member was uniformly charged.

In contrast, Comparative Examples 1 to 6, not including the structure of the present disclosure, showed a significant increase in resistance after image output in the aforementioned environment, and notable adverse effects occurred in image evaluation.

### <<Charging Roller>>

### <Production of NBR Rubber Elastic Roller>

Materials of the types and blending amounts shown in Table 14 below were mixed with a pressurized kneader to prepare a masterbatch rubber composition.

TABLE 14

| | Parts by |
|---|---|
| Material | Mass |
| NBR Rubber (trade name: Nipol DN219; manufactured by Zeon Corporation) | 100.0 |
| Carbon Black (trade name: TOKABLACK #4300; manufactured by Tokai Carbon Co., Ltd.) | 40.0 |
| Calcium Carbonate (NANOX#30; manufactured by Maruo Calcium Co., Ltd.) | 20.0 |
| Stearic Acid (trade name: Stearic Acid S; manufactured by Kao Corporation) | 1.0 |

166.0 parts by mass of the masterbatch rubber composition and respective materials of the types and blending amounts shown in Table 15 below were mixed with an open roll to prepare an unvulcanized rubber composition.

TABLE 15

| | Parts by |
|---|---|
| Material | Mass |
| Sulfur (trade name: Sulfax 200S; manufactured by | 1.2 |
| Tsurumi Chemical Industry Co., Ltd.) | |
| Tetrabenzylthiuram Disulfide (trade name: TBZTD; | 4.5 |
| manufactured by Sanshin Chemical Industry Co., Ltd.) | |

Next, a crosshead extruder equipped with a supply mechanism for conductive shafts and a discharge mechanism for unvulcanized rubber rollers was prepared. A die with an inner diameter of 16.5 mm was attached to the crosshead, the crosshead extruder temperature was adjusted to 80° C., and the conveyance speed for conductive shafts was adjusted to 60 mm/sec.

Under these conditions, the unvulcanized rubber composition was supplied from the extruder and coated as an unvulcanized rubber layer onto the peripheral surface of the prepared conductive shaft within the crosshead, and thus, an unvulcanized rubber roller was obtained.

Next, the unvulcanized rubber roller was placed in a hot-air vulcanization furnace at 170° C. and heated for 60 minutes to obtain an unpolished conductive roller. Thereafter, the ends of an NBR rubber elastic layer, which was formed by vulcanizing the unvulcanized rubber layer, were cut and removed, and the surface of the NBR rubber elastic layer was polished with a rotating grinding wheel. In this manner, an elastic roller K-2, in which the diameter at each position 90 mm from the center toward both ends was 8.4 mm, and the center diameter was 8.5 mm, was produced.

### <Charging Rollers TD-1 and TDH-1>

Charging rollers TD-1 and TDH-1 were obtained in the same manner as the developing roller 1, except that the elastic roller K-2 was used as the elastic layer. Details are shown in Table 16.

TABLE 16

| | | | | | | | | Proportion of |
|---|---|---|---|---|---|---|---|---|
| | | | | | | Amount of | | Bis(fluorosulfonyl)i |
| | | | | | | Anionic | | mide Anion in |
| | | | | | | Components | Proportion of | Anionic |
| | | | | | | Contained in | First and Second | Components to |
| | | Ionic | | | | Conductive Layer | Resins to Resins | Anionic |
| | | Conductive | | Impregnating | | per 100 Parts by | Contained in | Components |
| Charging | Elastic | Agent | | Liquid | | Mass of Binder | First Region of | Contained in |
| Roller | Roller | | Contained | | Contained | Resin (Parts by | Conductive | Conductive Layer |
| No. | No | No. | Structure | No. | Structure | Mass) | Layer (Mass %) | (Mass %) |
| TD-1 | K-2 | A-1 | C-1 | G-1 | C-3 | 0.1 | 99 | 100 |
| TDH-1 | K-2 | A-1 | C-1 | GH-1 | C-3 | 0.1 | 99 | 100 |

### <Evaluation of Charging Roller>

### [Evaluation of Horizontal Streak Image]

Next, for the obtained charging rollers, the aforementioned evaluation of fluctuation in roller resistance was conducted, and the following items were evaluated using these rollers as charging rollers.

Changes in conductivity (increase in electrical resistance) due to the energization of a charging roller may cause fine, streak-like density unevenness (horizontal streak) in a halftone image. Such an image is referred to as a “horizontal streak image.” The horizontal streak image tends to occur more frequently as the conductivity of the charging roller largely changes, and tends to become more conspicuous with the long-term use of the electrophotographic apparatus. The electrophotographic member of the present disclosure was incorporated as a charging roller into an electrophotographic apparatus, and the following evaluation was conducted.

The conductive rollers obtained in Example 28 and Comparative Example 7 were installed as charging rollers in an electrophotographic laser printer (trade name: HP Color LaserJet Enterprise CP4515dn, manufactured by HP Inc.) used as an electrophotographic apparatus. Then, a durability test was conducted by continuously outputting images with a print density of 4% (images in which horizontal lines with a width of 2 dots and an interval of 50 dots were drawn in the direction perpendicular to the rotation direction of the photosensitive member).

Besides, after the continuous output of 24000 sheets, a halftone image (an image in which horizontal lines with a width of 1 dot and an interval of 2 dots were drawn in the direction perpendicular to the rotation direction of the photosensitive member) was output for an image check. The obtained image was visually observed to evaluate fine, streak-like density unevenness (horizontal streak). The evaluation results are shown in Table 17.
A: A level at which no horizontal streaks occur.
B: A level at which horizontal streaks occur slightly only at the image ends.
C: A level at which horizontal streaks occur over approximately half the area of the image and are conspicuous.

TABLE 17

| | | | | | | | | | | | | Roller | | |
|---|---|---|---|---|---|---|---|---|---|---|---|---|---|---|
| | | | | | | | | | | | Initial | Resistance | | |
| | | Charging | | | | | | | | | Roller | after | | |
| | Comparative | Roller | | | | | | | | | Resistance | Energization | Energization | Horizontal |
| Example | Example | No. | Toner | A1 | A2 | α/β | T1 | T2 | T3 | α/γ | (Ω) | (Ω) | Degradation | Streak |
| 27 | — | TD-1 | L-1 | 395.4 | 392.2 | 90.1 | 382.6 | 378.5 | 379.6 | 1.0 | 5.77E+05 | 7.42E+05 | 1.29 | A |
| — | 7 | TDH-1 | L-1 | 395.7 | 395.5 | 507.4 | 391.5 | 387.4 | 388.5 | 3.0 | 5.62E+07 | 2.26E+08 | 4.02 | C |

In the charging rollers of Example and Comparative Example shown in Table 17, it was confirmed by the analytical operation by the aforementioned pyridine decomposition method that the formula (1) was satisfied, and it was also confirmed that an IPN structure was present in both the developing rollers.

### <Discussion of Evaluation Results>

The electrophotographic member produced in Example 27 contained, in the conductive layer used as the conductive layer of the present disclosure, the compound having the structure of the present disclosure, and therefore, showed little rise in resistance after image output in a 0° C. environment, and sustained high image quality.

In contrast, Comparative Example 7, not including the structure of the present disclosure, showed a significant increase in resistance after image output in the aforementioned environment, and notable adverse effects occurred in image evaluation.

### <<Developing Blades GB-1 and GBH-1>>

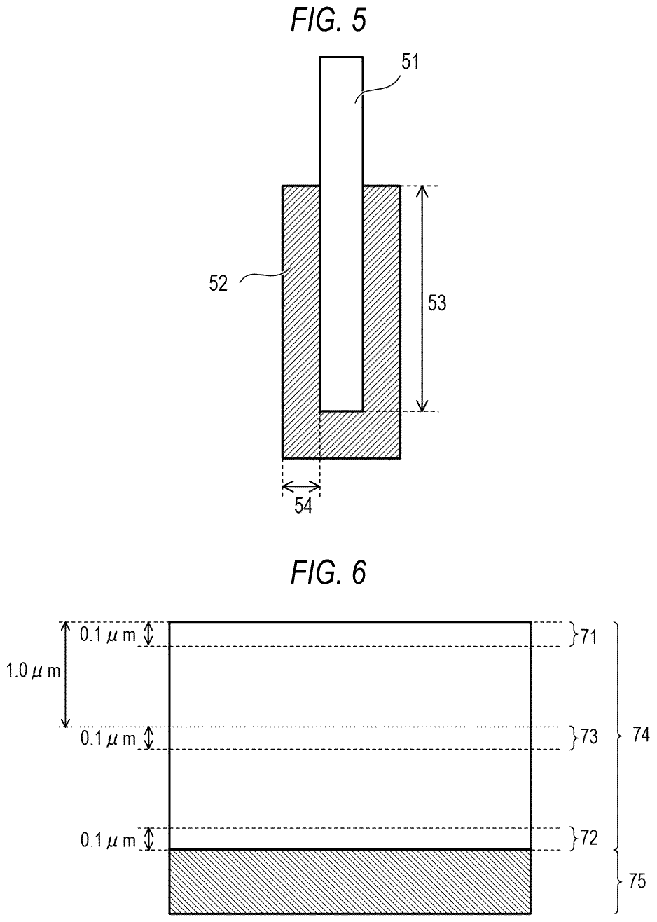

FIG. 5 is a cross-sectional view of the electrophotographic member produced in Examples. As a substrate 51, a SUS sheet with a thickness of 0.08 mm (manufactured by Nisshin Steel Co., Ltd.) was press-cut into a dimension of 200 mm in length and 23 mm in width.

Next, the cut SUS sheet was immersed in the conductive layer-forming coating material E-1 such that a length 53 from the longitudinal end of the cut SUS sheet was 1.5 mm, and thus, a coating film of the coating material was formed and then dried. Furthermore, a heat treatment was performed at 140° C. for 1 hour to produce a precursor of a developing blade DB-1 (electrophotographic member precursor).

Subsequently, the precursor was subjected to a treatment of being immersed in the impregnating liquid G-1 for 2 seconds to be impregnated with a (meth)acrylic component, such as an ionic conductive monomer. Thereafter, air-drying was performed at room temperature for 30 minutes, followed by drying at 90° C. for 1 hour to volatilize the solvent.

While being rotated, the dried developing blade was irradiated with ultraviolet rays such that the cumulative light intensity was 15000 mJ/cm², and thus, the (meth)acrylic monomer was cured to form a resin layer 52 as the conductive layer.

A high-pressure mercury lamp (trade name: Handy-type UV Curing System, manufactured by Mario Network Co., Ltd.) was used as the ultraviolet irradiation apparatus. Thus, a developing blade GB-1 to be used in Example was obtained.

A developing blade GBH-1 of Comparative Example was produced in the same manner as in the above-described Example, except that the impregnating liquid was changed to GH-1. Details are shown in Table 18.

TABLE 18

| | | | | | Amount of | | |
|---|---|---|---|---|---|---|---|
| | | | | | Anionic | | Proportion of |
| | | | | | Components | Proportion of First | Bis(fluorosulfony1)imide |
| | | | | | Contained in | and Second Resins | Anion in Anionic |
| | Ionic | | | | Conductive Layer | to Resins | Components to Anionic |
| | Conductive | | Impregnating | | per 100 Parts by | Contained in First | Components Contained |
| | Agent | | Liquid | | Mass of Binder | Region of | in Conductive Layer |
| Developing | | Contained | | Contained | Resin (Parts by | Conductive Layer | (Mass %) |
| Blade No. | No. | Structure | No. | Structure | Mass) | (Mass %) | |
| DB-1 | A-1 | C-1 | G-1 | C-3 | 0.1 | 99 | 100 |
| DBH-1 | A-1 | C-1 | GH-1 | C-3 | 0.1 | 99 | 100 |

### <Evaluation of Developing Blade>

### [Evaluation of Electric Resistance Value]

The electric resistance value of the developing blades was measured in the same manner as in the measurement of the resistance of the conductive rollers described above. However, the roller-shaped electrophotographic member 1 in FIG. 4A is replaced here by the developing blade shown in FIG. 5. Specifically, the bearings 38 were brought into contact with both longitudinal ends of the substrate 51 of the blade member illustrated in FIG. 5, and with a load of 1.0 N applied to each, the resin layer at the tip of the blade member was brought into contact with the peripheral surface of the cylindrical metal member 37 so as to be perpendicular thereto.

Next, without rotating the cylindrical metal member 37, a voltage of 50 V was applied by the high-voltage power supply 39, and the potential difference between both ends of a resistor having a known electrical resistance (the electrical resistance of which is lower than that of the electrophotographic member 1 by two orders of magnitude or more) disposed between the cylindrical metal member 37 and the ground was measured. A voltmeter 40 (189 TRUE RMS MULTIMETER, manufactured by FLUKE Corporation) was used for the measurement of the potential difference. From the measured potential difference and the electrical resistance of the resistor, the current flowing to the cylindrical metal member 37 through the developing blade was obtained by calculation.

The electrical resistance value of the electrophotographic member 1 was obtained by dividing the applied voltage of 50 V by the obtained current. Here, the potential difference was measured by sampling for 3 seconds starting from 2 seconds after the voltage application, and a value calculated from the average value thereof was determined as the resistance value.

### [Evaluation of Regulation Failure]

The electrophotographic member to be evaluated was installed as a developing blade in the laser printer (trade name: LBP7700C; manufactured by CANON KABUSHIKI KAISHA) having the structure illustrated in FIG. 3. After the laser printer was placed in a 0° C. environment and left for 2 hours or more, 100 images in black with a print coverage of 1% were continuously output. Subsequently, a solid white image was output on a new sheet of copy paper.

After outputting these images, the state of the toner coat on the surface of the developing member was observed, and the presence or absence of electrostatic toner aggregation (regulation failure) caused by abnormal charging of the toner was visually observed. The observation results were evaluated according to the following criteria. The evaluation results are shown in Table 19.
A: Regulation failure is not present on the toner coat.
B: Regulation failure is present on the toner coat, but does not appear in the images.
C: Regulation failure appears in the images.

TABLE 19

| | | | | | | | | | | | | Roller | | |
|---|---|---|---|---|---|---|---|---|---|---|---|---|---|---|
| | | | | | | | | | | | Initial | Resistance | | |
| | | Developing | | | | | | | | | Roller | after | | |
| | Comparative | Blade | | | | | | | | | Resistance | Energization | Energization | Regulation |
| Example | Example | No. | Toner | A1 | A2 | α/β | T1 | T2 | T3 | α/γ | (Ω) | (Ω) | Degradation | Failure |
| 28 | — | DB-1 | L-1 | 395.7 | 392.5 | 89.3 | 382.8 | 378.6 | 379.8 | 1.0 | 1.11E+08 | 1.56E+08 | 1.41 | A |
| — | 8 | DBH-1 | L-1 | 395.9 | 392.7 | 512.2 | 391.9 | 387.7 | 388.9 | 3.0 | 1.50E+09 | 4.85E+09 | 3.24 | C |

In the developing blades of Example and Comparative Example shown in Table 19, it was confirmed by the analytical operation by the aforementioned pyridine decomposition method that the formula (1) was satisfied, and it was also confirmed that an IPN structure was present in both the developing blades.

### <Discussion of Evaluation Results>

Since the developing blade of Example 28 contained the structure of the present disclosure, it showed little rise in resistance after image output in a 0° C. environment, and regulation failure did not occur therein. In contrast, the developing blade of Comparative Example 8 showed an increase in the resistance value, and regulation failure occurred. It is considered that the regulation failure under the 0° C. environment occurred because the resistance of the developing blade increased, the blade bias was not applied up to a specified value, and therefore, the charging of the toner was non-uniform.

According to at least one aspect of the present disclosure, an electrophotographic member that contributes to stable formation of a high-quality electrophotographic image in a low-temperature environment can be obtained. Besides, according to at least one aspect of the present disclosure, an electrophotographic process cartridge that contributes to stable formation of a high-quality electrophotographic image can be obtained. Furthermore, according to at least one aspect of the present disclosure, an electrophotographic image forming apparatus capable of stably forming a high-quality electrophotographic image can be obtained.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034956, filed Mar. 5, 2025, which is hereby incorporated by reference herein in its entirety.

What is claimed is:

1. An electrophotographic member comprising a substrate and a conductive layer on the substrate,
wherein the conductive layer has a thickness of 0.1 μm or more,
the conductive layer contains a first resin, a second resin and a bis(fluorosulfonyl)imide anion,
the first resin is a crosslinked urethane resin containing, in a molecule, at least one selected from the group consisting of a cationic structure represented by the following formula (C-1) and a cationic structure represented by the following formula (C-2) as well as a polymer chain,
the second resin is a crosslinked acrylic resin containing, in a molecule, at least one selected from the group consisting of a partial structure represented by the following formula (C-3), a partial structure represented by the following formula (C-4) and a partial structure represented by the following formula (C-5) as well as a polymer chain,
when a region extending from an outer surface of the conductive layer to a depth of 0.1 μm is defined as a first region, the first resin and the second resin form an interpenetrating polymer network structure in the first region: 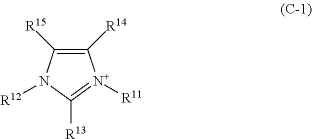
wherein R¹¹ to R¹⁵ are each independently any one selected from the group consisting of the following (a) to (c), and any two of R¹¹ to R¹⁵ are (c):
(a) a hydrogen atom;
(b) a saturated hydrocarbon group having 1 to 6 carbon atoms; and
(c) a structure including a moiety bonded to the polymer chain of the crosslinked urethane resin, 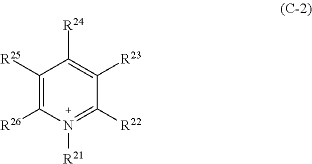
wherein R²¹ to R²⁶ are each independently any one selected from the group consisting of the (a) to (c), and any two of R²¹ to R²⁶ are (c), 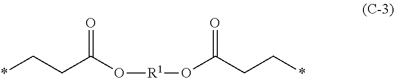
wherein R¹ represents a structure containing carbon, hydrogen and oxygen, having 2 to 8 carbon atoms, and * represents a structure including a moiety bonded to the polymer chain of the crosslinked acrylic resin, 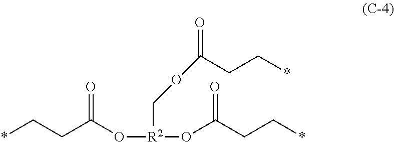
wherein R² represents a structure containing carbon, hydrogen and oxygen, having 3 to 8 carbon atoms, and * represents a structure including a moiety bonded to the polymer chain of the crosslinked acrylic resin, and 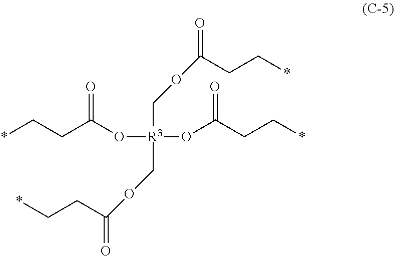
wherein R³ represents a structure containing carbon, hydrogen and oxygen, having 3 to 8 carbon atoms, and * represents a structure including a moiety bonded to the polymer chain of the crosslinked acrylic resin.

2. The electrophotographic member according to claim 1,
wherein the first region includes the first resin and the second resin,
when a peak top temperature in a thermal chromatogram derived from the second resin measured in a first sample sampled from the first region is defined as A1 (° C.), and a peak top temperature in a thermal chromatogram derived from the second resin measured in a second sample obtained by decomposing the first resin contained in the first sample is defined as A2 (° C.), the A1 and the A2 satisfy a relationship represented by the following formula (1):
$$A 1 > A 2 \qquad ( 1 )$$
when a peak area of carbon (1s) atom having a binding energy peak position in a range of 286.0 eV to 287.0 eV, as measured by electron spectroscopy for chemical analysis (ESCA), of the second sample is defined as α, and a peak area of sulfur (2p3/2) atom having a binding energy peak position in a range of 166.0 eV to 170.0 eV is defined as β, the α and the β satisfy the following formula (2):
$$300 > α / β . \qquad ( 2 )$$

3. The electrophotographic member according to claim 1,
wherein when a peak top temperature in a thermal chromatogram corresponding to the first resin in the first region is defined as T1 (° C.), a region having a thickness of 0.1 μm from an inner surface of the conductive layer toward an outer surface is defined as a second region, and a peak top temperature in a thermal chromatogram corresponding to the first resin contained in the second region is defined as T2 (° C.), the T1 and the T2 satisfy a relationship represented by the following formula (3):
$$T 1 > T 2 . \qquad ( 3 )$$

4. The electrophotographic member according to claim 2,
wherein when a peak area of carbon (1s) atom having a binding energy peak position in a range of 288 eV to 290 eV, as measured by electron spectroscopy for chemical analysis (ESCA), of the second sample is defined as γ, the α and the γ satisfy the following formula (4):
$$1.5 > α / γ . \qquad ( 4 )$$

5. The electrophotographic member according to claim 1, wherein a monomer forming the second resin is a trifunctional or higher monomer.

6. The electrophotographic member according to claim 1, wherein a content of an anionic component in the conductive layer is 0.01 parts by mass or more and 0.2 parts by mass or less based on 100 parts by mass of a total content of the first resin and the second resin contained in the conductive layer.

7. The electrophotographic member according to claim 1, wherein the first resin and the second resin occupy 80% by mass or more of resins contained in the first region in the conductive layer.

8. The electrophotographic member according to claim 1, wherein the bis(fluorosulfonyl)imide anion occupies 80% by mass or more of anionic components contained in the conductive layer.

9. A developing apparatus comprising a toner and a developing roller carrying the toner on a surface thereof,
wherein the developing roller is an electrophotographic member comprising a substrate and a conductive layer on the substrate,
the conductive layer has a thickness of 0.1 μm or more,
the conductive layer contains a first resin, a second resin and a bis(fluorosulfonyl)imide anion,
the first resin is a crosslinked urethane resin containing, in a molecule, at least one selected from the group consisting of a cationic structure represented by the following formula (C-1) and a cationic structure represented by the following formula (C-2) as well as a polymer chain,
the second resin is a crosslinked acrylic resin containing, in a molecule, at least one selected from the group consisting of a partial structure represented by the following formula (C-3), a partial structure represented by the following formula (C-4) and a partial structure represented by the following formula (C-5) as well as a polymer chain,
when a region extending from an outer surface of the conductive layer to a depth of 0.1 μm is defined as a first region, the first resin and the second resin form an interpenetrating polymer network structure in the first region,
the toner comprises a toner particle having a toner mother particle containing a binder resin and an organosilicon polymer disposed on a surface of the toner mother particle,
the toner mother particle has, on the surface thereof, a convex portion formed of the organosilicon polymer, 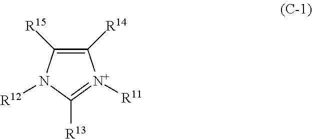
wherein R¹¹ to R¹⁵ are each independently any one selected from the group consisting of the following (a) to (c), and any two of R¹¹ to R¹⁵ are (c):
(a) a hydrogen atom;
(b) a saturated hydrocarbon group having 1 to 6 carbon atoms; and
(c) a structure including a moiety bonded to the polymer chain of the crosslinked urethane resin, 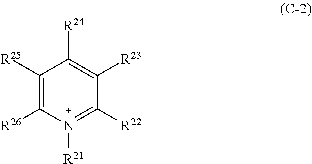
wherein R²¹ to R²⁶ are each independently any one selected from the group consisting of the (a) to (c), and any two of R²¹ to R²⁶ are (c), 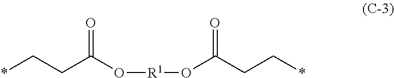
wherein R¹ represents a structure containing carbon, hydrogen and oxygen, having 2 to 8 carbon atoms, and * represents a structure including a moiety bonded to the polymer chain of the crosslinked acrylic resin, 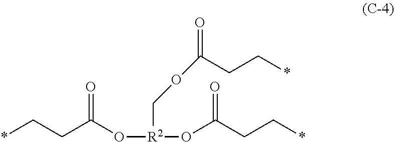
wherein R² represents a structure containing carbon, hydrogen and oxygen, having 3 to 8 carbon atoms, and * represents a structure including a moiety bonded to the polymer chain of the crosslinked acrylic resin, and 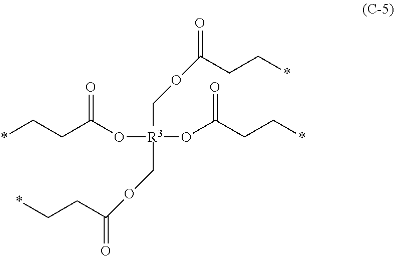
wherein R³ represents a structure containing carbon, hydrogen and oxygen, having 3 to 8 carbon atoms, and * represents a structure including a moiety bonded to the polymer chain of the crosslinked acrylic resin.

10. An electrophotographic process cartridge configured to be detachably mountable to a main body of an electrophotographic image forming apparatus, the electrophotographic process cartridge comprising the developing apparatus according to claim 9.

11. An electrophotographic image forming apparatus, comprising the electrophotographic process cartridge according to claim 10.
